(19) United States
(12) Patent Application Publication
(10) Pub. No.: US 2015/0095483 A1
(43) Pub. Date: Apr. 2, 2015

(54) COMMUNICATIONS TERMINAL, TRANSFER TERMINAL, AND CONTENT PUBLICATION METHOD

(71) Applicant: Panasonic Corporation, Osaka (JP)

(72) Inventors: EIICHI MURAMOTO, Kanagawa (JP); TAKAHIRO YONEDA, Osaka (JP); KAZUNOBU KONISHI, Osaka (JP); RYOTA OHNISHI, Osaka (JP)

(21) Appl. No.: 14/491,030

(22) Filed: Sep. 19, 2014

(30) Foreign Application Priority Data
Sep. 27, 2013 (JP) 2013-201724

(51) Int. Cl. H04L 29/08

(52) U.S. Cl. CPC H04L 67/10
USPC 709/223

(57) ABSTRACT

A communications terminal that forms CCN includes an original content obtaining unit configured to obtain original content including original blocks, a content editing unit configured to generate edited content including edited blocks from the original content, a name deciding unit configured to decide upon a name of the edited content and names of the edited blocks, and a publishing unit configured to publish the edited blocks and index information of the edited content. In the case where an edited block, among the edited blocks, has contents identical to contents of a corresponding one of the original blocks, the name deciding unit decides that the name of the original block is to be the name of the edited block.

### BACKGROUND OF THE INVENTION

1. Field of the Invention

The present disclosure relates to a communications terminal and a transfer terminal that form a content centric network, and a content publication method over a content centric network.

2. Description of the Related Art

In recent years, a technology called content centric network (CCN), which is described in Derek Kulinsk et al., “NDNVideo: Random-access Live and Pre-recorded Streaming using NDN”, Technical Report NDN-0007, 2012, has been attracting attention. CCN is a content distribution infrastructure that manages pieces of content using their names.

In CCN, content is obtained in the following manner. First, a communications terminal that attempts to obtain content transmits an interest packet specifying the name of the content. The transmitted interest packet is transferred by many transfer terminals located over CCN like a net, to a communications terminal that stores content assigned the name. The communications terminal that has received the interest packet then transmits a packet after storing data of the content assigned the name in the packet. The transmitted data packet is transferred by many transfer terminals in a direction opposite to that of the interest packet, and reaches the communications terminal that has transmitted the interest packet.

Some of features of CCN are a data cache function and an interest-packet response function provided by transfer terminals. Transfer terminals such as routers cache a duplicate of transferred data therein. Then, upon receipt of an interest packet specifying the name of the data, the transfer terminals return the cached data to the transmission source of the interest packet instead of transferring the interest packet.

Such functions provided by transfer terminals advantageously enable CCN to efficiently distribute content while suppressing a transfer load of the network. For this reason, application of CCN to public communications networks such as the Internet is expected.

Distribution of content of real-time stream data (hereinafter, simply referred to as “content”) such as music content and video content over existing communications networks such as the Internet is widely carried out. Accordingly, such content is desirably distributed more efficiently over CCN.

A technique for managing in which device each of a plurality of blocks constituting content is stored is described in U.S. Patent Application Publication No. 2012/0158973, for example. Also, a technique for dividing a process for obtaining content into two-step processes, that is, accessing index information indicating a position of each block within the content and accessing each block using the index information, is described in Derek Kulinsk et al., “NDNVideo: Random-access Live and Pre-recorded Streaming using NDN”, Technical Report NDN-0007, 2012, for example. These techniques of the related art enable efficient obtainment of each of a plurality of blocks constituting content, and consequently enable efficient distribution of the content.

### SUMMARY OF THE INVENTION

In the related art, edited content is treated as another content different from its original content even if the edited content and the original content have common contents. Accordingly, in the related art, it is unfortunately difficult to utilize cached original content for distribution of edited content.

One non-limiting and exemplary embodiment provides a communications terminal that enables utilization of cached original content for distribution of edited content. Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

In one general aspect, the techniques disclosed here feature: a communications terminal that forms a content centric network, including an original content obtaining unit configured to obtain original content including original blocks having names; a content editing unit configured to generate edited content including edited blocks from the original content; a name deciding unit configured to decide upon a name of the edited content and names of the edited blocks; and a publishing unit configured to publish the edited blocks and index information of the edited content, wherein in a case where an edited block, among the edited blocks, has contents identical to contents of a corresponding one of the original blocks, the name deciding unit decides that the name of the original block is to be the name of the edited block.

These general and specific aspects may be implemented using a system, a method, and a computer program, and any combination of systems, methods, and computer programs.

In accordance with embodiments of the present disclosure, cached original content can be utilized for distribution of edited content.

### BRIEF DESCRIPTION OF THE DRAWINGS

FIG. 1 is a block diagram illustrating an example of a configuration of a communications terminal according to a first embodiment of the present disclosure.

FIG. 2 is a system configuration diagram illustrating a configuration of a communications system including a communications terminal according to a second embodiment of the present disclosure.

FIG. 3 is a diagram illustrating an example of the overview of edited content in the second embodiment.

FIG. 4 is a diagram illustrating a design example of namespaces in the second embodiment.

FIG. 5 is a block diagram illustrating an example of a configuration of an editing terminal in the second embodiment.

FIG. 6 is a block diagram illustrating an example of a configuration of a transfer terminal in the second embodiment.

FIG. 7 is a flowchart illustrating an example of an operation performed by the editing terminal in the second embodiment.

FIG. 8 is a flowchart illustrating an example of a content obtaining process in the second embodiment.

FIG. 9 is a flowchart illustrating an example of a content editing process in the second embodiment.

FIG. 10 is a flowchart illustrating an example of an interest packet responding process in the second embodiment.

FIG. 11 is a flowchart illustrating an example of an operation performed by the transfer terminal in the second embodiment.

FIG. 12 is a diagram illustrating an example of contents set in a forwarding information base (FIB) unit in the second embodiment.

FIG. 13 is a diagram illustrating an example of contents set in a content store (CS) unit in the second embodiment.

FIG. 14 is a flowchart illustrating an example of an interest packet handling process in the second embodiment.

FIG. 15 is a sequence diagram illustrating an example of a flow of how packets are exchanged in the second embodiment.

FIG. 16 is a system configuration diagram illustrating an example of a configuration of a communications system according to a third embodiment of the present disclosure.

FIG. 17 is a diagram illustrating a design example of namespaces in the third embodiment.

FIG. 18 is a block diagram illustrating an example of a configuration of an editing terminal in the third embodiment.

FIG. 19 is a block diagram illustrating an example of a configuration of a transfer terminal in the third embodiment.

FIG. 20 is a flowchart illustrating an example of the interest packet handling process performed by the transfer terminal in the third embodiment.

### DESCRIPTION OF THE PREFERRED EMBODIMENTS

Firstly, items studied by the inventions of the present disclosure will be described prior to the description of each exemplary embodiment of the present disclosure.

Hitherto, the following has been performed. A user different from a user who has distributed content edits the distributed content, and distributes the edited content. The edited content is, for example, a short digest video that summarizes a long video or a video obtained by further performing image editing on this video. Desirably, such edited content is also efficiently distributed over CCN.

Accordingly, it is considered to utilize, in the case where edited content has contents that are common to those of content (hereinafter, referred to as “original content”) from which the edited content has been derived, cached original content for distribution of the edited content.

Embodiments of the present disclosure will be described in detail below with reference to the accompanying drawings.

### First Embodiment

A first embodiment of the present disclosure is an example of a basic aspect of the present disclosure.

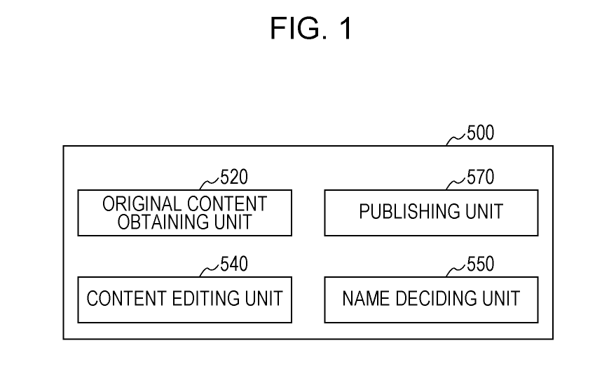

FIG. 1 is a block diagram illustrating an example of a configuration of a communications terminal according to the first embodiment.

Referring to FIG. 1, a communications terminal 500 includes an original content obtaining unit 520, a content editing unit 540, a name deciding unit 550, and a publishing unit 570.

The original content obtaining unit 520 obtains original content including original blocks having names.

The content editing unit 540 generates edited content including edited blocks from the original content.

The name deciding unit 550 decides upon a name of the edited content and names of the edited blocks. Note that in the case where an edited block has the same contents as its original block, the name deciding unit 550 decides that the name of the original block is to be the name of the edited block.

The publishing unit 570 publishes the edited blocks and index information of the edited content.

Although not illustrated, the communications terminal 500 also includes, for example, a central processing unit (CPU), a storage medium such as a read only memory (ROM) storing a control program, a work memory such as a random access memory (RAM), and a communications circuit. In this case, functions of the above-described units are implemented as a result of the CPU executing the control program.

As described above, in the case where an edited block has the same contents as its original block, the communications terminal 500 according to the first embodiment publishes the edited block and index information of the edited content by using the name of the original block.

With this configuration, when the edited block is searched for on the basis of index information of the edited content, cashed original block having the same contents as the edited block is retrieved and this cached original block can be obtained.

Therefore, the communications terminal 500 according to the first embodiment enables utilization of cached original content for distribution of edited content.

### Second Embodiment

A second embodiment of the present disclosure is an example of a specific aspect of the present disclosure for the case where content includes real-time stream data.

### DEFINITIONS OF TERMS

First, definitions of major terms used in the second embodiment will be described.

The term “content” refers to real-time stream data of audio, video, or the like to be distributed over a network. Types of content include original content (original data) and edited content (edited data) obtained by editing original content.

The term “content name” refers to a name of content in a certain namespace.

The term “block” refers to a collection of data obtained by dividing data constituting content along a time axis, and a unit in which data of video, audio, or the like is accessed. Specifically, a block is, for example, a collection of a plurality of Moving Picture Experts Group 2-Transport Stream (MPEG2-TS) packets or a collection of H.264 packets defined by RFC3984, of Real-time Transport Protocol (RTP) packets defined by RFC3551, or of payloads of these packets.

The term “block name” refers to a name of a block in the certain namespace. Note that each block is assigned a block name as part of its data.

The term “index information (index)” refers to information indicating, for each content, an association among a content name, positions of blocks constituting the content within the content, and block names of the blocks constituting the content. A position within content is indicated by, for example, a reproduction time along the time axis of real-time stream data.

The term “data packet” refers to a packet that stores index information or part or entirety of a block therein.

The term “CCN” is an abbreviation for content centric network, and indicates a content distribution infrastructure that manages pieces of content using their names. In the second embodiment, a communications terminal that makes a request for distribution of content performs two-step processes of accessing index information and accessing a block, whereby CCN implements content distribution.

The term “interest packet” refers to a packet used to make a request for returning of data. Types of interest packet include a packet used to make a request for returning of index information and a packet used to make a request for returning of a block.

The term to “publish” refers to registering in CCN the fact that a terminal is capable of transmitting a response (data packet) to an interest packet specifying certain data. That is, to “publish” refers to an action for making data obtainable in response to issuance of an interest packet specifying the name of the data, and for requesting another terminal in a CCN network to transmit an interest packet based on a specific namespace. Specifically, to “publish” refers to an action performed by a first communications terminal to register information causing a second terminal to transfer to the first communications terminal an interest packet including information that follows the specific namespace, in the second terminal as a property of a virtual interface (which is called “face” in Derek Kulinsk et al., “NDNVideo: Random-access Live and Pre-recorded Streaming using NDN”, Technical Report NDN-0007, 2012) which is automatically generated in the second terminal when the first communications terminal establishes a connection to the second terminal located nearby. The CCN network registers such information in a forwarding information base (FIB) and also transfers and distributes such information to individual terminals in the CCN network using a certain path control program (for example, Open Shortest Path First for Named data (OSPFN)). That is, the registration includes a process for informing other terminals of a prefix of the content name.

### <Overview of Communications System>

Next, a configuration of a communications system including a communications terminal according to the second embodiment will be described.

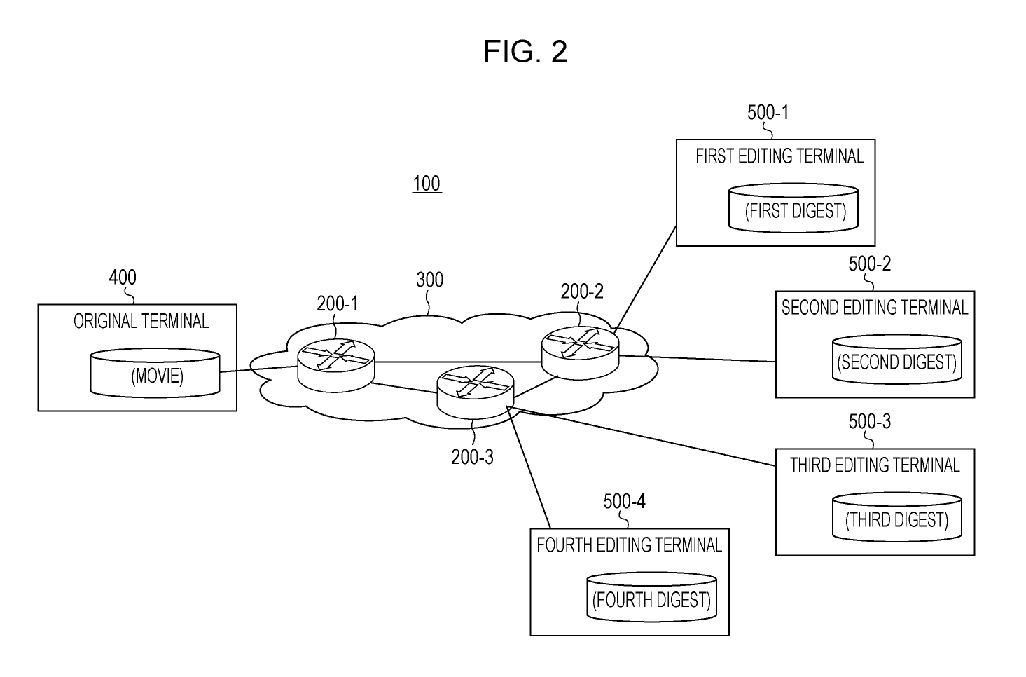

FIG. 2 is a system configuration diagram illustrating a configuration of a communications system including a communications terminal according to the second embodiment.

Referring to FIG. 2, a communications system 100 includes a communications network 300, an original terminal 400, and first to fourth editing terminals 500-1 to 500-4. Over the communications network 300, first to third transfer terminals 200-1 to 200-3 are located. The original terminal 400 and the first to fourth editing terminals 500-1 to 500-4 are connected to the communications network 300. The communications system 100 forms a CCN network.

Note that in the following description, the first to third transfer terminals 200-1 to 200-3 are collectively referred to as “transfer terminals 200” as appropriate because they have the same configuration. Also, the first to fourth editing terminals 500-1 to 500-4 are collectively referred to as “editing terminals 500” as appropriate because they have the same configuration.

The transfer terminal 200 is, for example, a router that supports CCN. The transfer terminal 200 transfers an interest packet and a data packet, and caches a duplicate of the transferred data packet therein. In the case where a data packet specified by a received interest packet is cached in the transfer terminal 200, the transfer terminal 200 returns the data packet to the transmission source of the interest packet.

The original terminal 400 is a terminal that publishes original content including real-time stream data among communications terminals that support CCN. That is, the original terminal 400 serves as a publisher of the original content. The original terminal 400 is, for example, a personal computer having a communication function.

The editing terminal 500 is a terminal that obtains original content from the original terminal 400, generates edited content from the original content, and publishes the edited content, among communications terminals that support CCN. That is, the editing terminal 500 serves as a publisher of the edited content. The editing terminal 500 is, for example, a personal computer having a communication function.

Suppose that, for example, the first editing terminal 500-1 has already obtained the original content over such a CCN network. In this case, data of the original content has been cached in the first and second transfer terminals 200-1 and 200-2 located along a path from the original terminal 400 to the first editing terminal 500-1.

Suppose that the second editing terminal 500-2 transmits an interest packet specifying the name of the original content in the case that data of the original content has been cached in the first and second transfer terminals 200-2 and 200-2. In this case, a data packet that stores the data of the original content therein is returned from the second transfer terminal 200-2 located closer to the second editing terminal 500-2 than the original terminal 400.

In the second embodiment, it is assumed that the original content includes video/audio stream data of a certain two-hour movie. It is also assumed that the editing terminals 500 are terminals each of which publishes, as edited content, a three-minute digest version (short version) of video/audio stream data (hereinafter, referred to as a “digest”) which serves as a preview version of the movie. It is also assumed that users of the first to fourth editing terminals 500-1 to 500-4 are, for example, engineers who have undertaken the job of creating and distributing digest versions of the movie from a user of the original terminal 400.

Note that in the following description, users of the first to fourth editing terminals 500-1 to 500-4 are referred to as first to fourth editors, respectively. Also, pieces of edited content generated by the first to fourth editing terminals 500-1 to 500-4 are referred to as first to fourth digests, respectively.

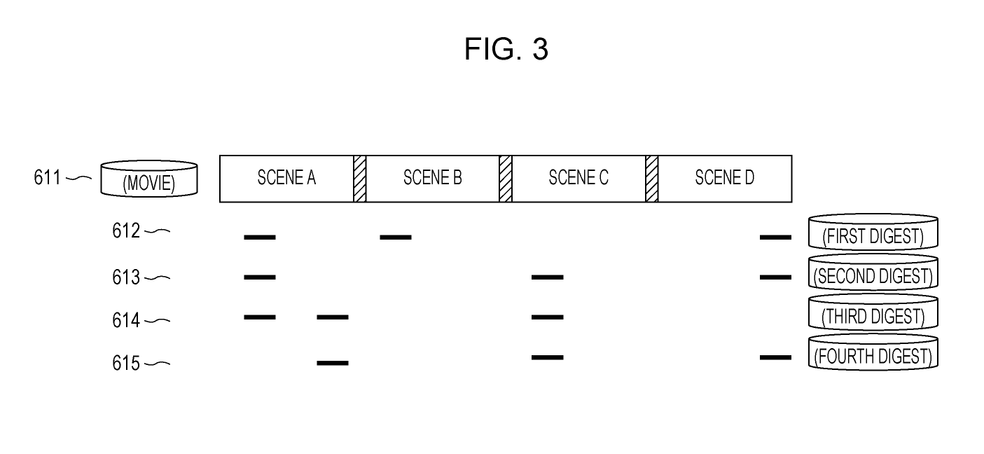

FIG. 3 is a diagram illustrating an example of the overview of pieces of edited content generated by the first to fourth editing terminals 500-1 to 500-4.

As illustrated in FIG. 3, a movie 611 serving as original content includes real-time stream data made up of scenes A to D. Each of the first to fourth digests 612 to 615 which are pieces of edited content is data obtained by extracting real-time stream data segments of a plurality of short intervals from the movie 611 and concatenating the extracted real-time stream data segments.

Patterns of intervals that constitute the first to fourth digests 612 and 615 are different from one another. That is, the movie 611 and the first to fourth digests 612 to 615 are pieces of content different from one another.

In the case where contents of the data segments extracted from the real-time stream data are not edited, the movie 611 and the first to fourth digests 612 to 615 have a common data portion (hereinafter, referred to as “common data”). Cached common data is desirably utilized regardless of whether this distribution is distribution of the movie 611 or any of the first to fourth digests 612 to 615.

However, because the publishers of the movie 611 and the first to fourth digests 612 to 615 are different from one another, the movie 611 and the first to fourth digests 612 to 615 are assigned different content names. Also, in the related art, blocks constituting content are given block names based on the content name of the content. For this reason, even if a plurality of pieces of content published by different publishers include common data, it is difficult to utilize such common data for distribution of the plurality of pieces of content.

Accordingly, in the case where an edited block has the same contents as its original block, the editing terminals 500 according to the second embodiment publish the edited block and index information of the edited content by using the name of the original block. With this configuration, blocks including common data come to have the same block name even if their publishers are different. That is, in the case where a plurality of pieces of content published by different publishers include common data, such common data can be utilized for distribution of the plurality of pieces of content.

Now, namespaces used in the communications system 100 will be described.

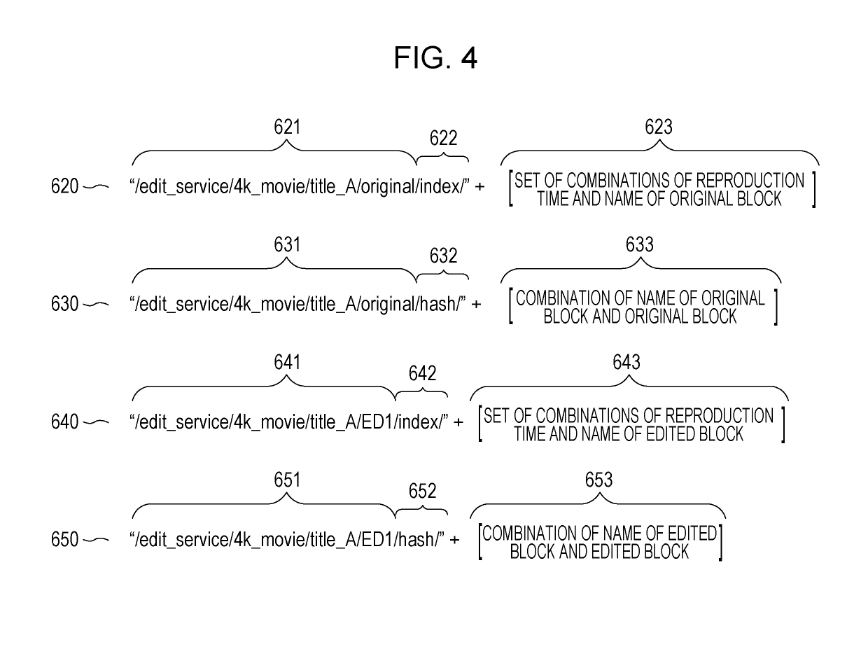

FIG. 4 is a diagram illustrating a design example of namespaces used in the communications system 100.

In the communications system 100, for example, an original content namespace 620, an original block namespace 630, an edited content namespace 640, and an edited block namespace 650 as illustrated in FIG. 4 are set.

The original content namespace 620 includes a prefix portion 621 for identifying a service within a CCN network, and data portions 622 and 623 each storing data therein.

The data portion 623 which follows “index/” in the original content namespace 620 stores a set of combinations of a reproduction time of an original block and a block name of the original block. Here, the reproduction time represents the time from which the original block is to be reproduced along the time axis of the real-time stream data of the original content.

For example, in the data portions 622 and 623 for “index/time00_{—}00_{—}01”, a block name of an original block to be reproduced from a time 01 (for example, one second after the start time of the original content) is stored. That is, by accessing the name in the original content namespace 620, a combination of an original block and its reproduction time can be obtained.

Therefore, information stored in the data portion 623 of the original content namespace 620 is index information of the original content.

Although not illustrated, for the namespace of “index/”, a special name “index/ALL” is defined which indicates that block names of all blocks in the namespace that follows “index/” are stored. It is defined that, in response to an interest packet specifying a content name including “index/ALL”, data including block names that follow “index/” is generated and is returned.

Further, although not illustrated, for the namespace of “index/”, another special name “index/LATEST” is defined which indicates that a block name of a block assigned the latest (largest) reproduction time among all blocks in part that follows “index/” is stored. An interest packet specifying a content name including “index/LATEST” is equivalent to an interest packet specifying a block name of a block assigned the latest reproduction time among all blocks in part that follows “index/”.

For example, as for the two-hour content, in response to an interest packet specifying “index/ALL”, “time00_{—}00_{—}01” to “time02_{—}00_{—}00” and block names corresponding to these times are returned. In contrast, in response to an interest packet specifying “index/LATEST”, “time02_{—}00_{—}00” and a block name corresponding to this time are returned.

Like the original content namespace 620, the original block namespace 630 includes a prefix portion 631, a data portion 632, and a data portion 633. However, the namespace of the data portion 632 of the original block namespace 630 starts with “hash/” instead of “index/”. The data portion 633 that follows “hash/” stores a combination of a block name of an original block and data of the original block.

Specifically, when obtaining original content, the editing terminal 500 first accesses the data portion 623 using the original content namespace 620, and obtains index information of the original content. Then, based on the obtained index information of the original content, the editing terminal 500 accesses the data portion 633 using the original block namespace 630, and obtains an entity of the original block.

Note that the index information need not strictly define the reproduction time of each original block. For example, the index information may define a rough position of each original block, such as the start time of a scene to which the original block belongs. In this case, the data portion 633 that follows “hash/” desirably further stores additional information regarding the reproduction time of the original block. Such additional information is, for example, a number (for example, “001”) representing the reproduction order within the entire original content or an offset value (for example, “after 0.1 second”) for the reproduction time of the original block relative to the start time of the scene described in the index information.

Like the original content namespace 620, the edited content namespace 640 includes a prefix portion 641, a data portion 642, and a data portion 643. Also, like the original block namespace 630, the edited block namespace 650 includes a prefix portion 651, a data portion 652, and a data portion 653.

Note that the prefix portion 641 of the edited content namespace 640 and the prefix portion 651 of the edited block namespace 650 are different from the prefix portion 621 of the original content namespace 620 and the prefix portion 631 of the original block namespace 630.

As described above, in the case where an edited block has the same contents as its original block, the editing terminal 500 according to the second embodiment publishes the edited block and index information of the edited content by using the name of the original block. This implies that the block name of the original block is stored as the block name of the edited block in the data portion 643 of the edited content namespace 640.

### <Configurations of Individual Terminals>

Next, configurations of the editing terminal 500 and the transfer terminal 200 will be described.

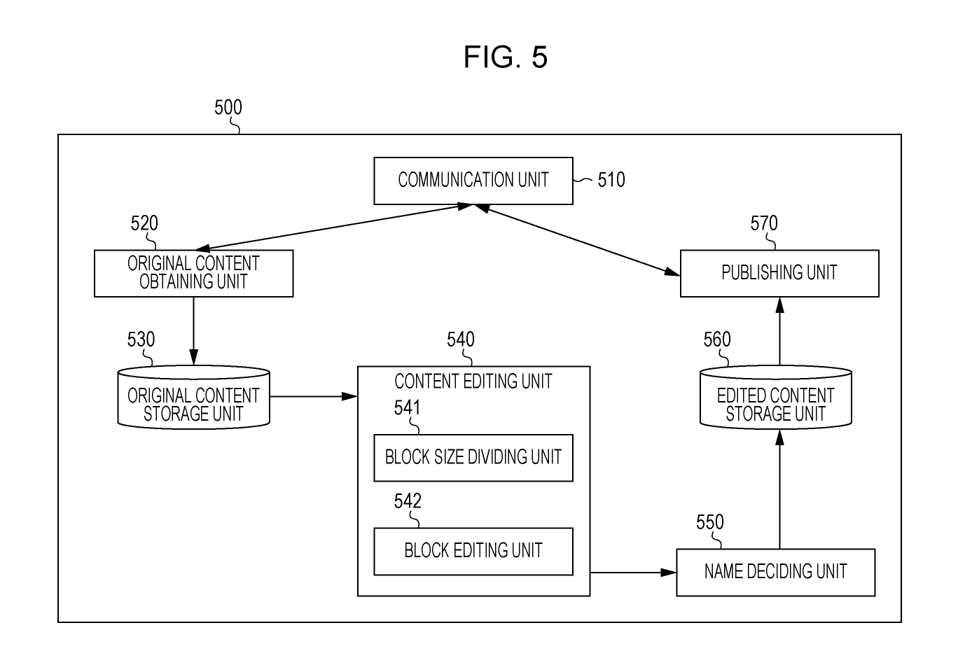

FIG. 5 is a block diagram illustrating an example of a configuration of the editing terminal 500.

Referring to FIG. 5, the editing terminal 500 includes a communication unit 510, the original content obtaining unit 520, an original content storage unit 530, the content editing unit 540, the name deciding unit 550, an edited content storage unit 560, and the publishing unit 570.

The communication unit 510 establishes a connection to a CCN network, and performs communication with other terminals.

The original content obtaining unit 520 obtains original content from the CCN network via the communication unit 510. Then, the original content obtaining unit 520 outputs the obtained original content to the original content storage unit 530.

The original content storage unit 530 stores the original content input from the original content obtaining unit 520.

The content editing unit 540 accepts editing to be preformed on the original content from a user, and generates edited content from the original content. The content editing unit 540 includes a block size dividing unit 541 and a block editing unit 542.

The block size dividing unit 541 obtains segment blocks which are obtained by dividing real-time stream data of the original content stored in the original content storage unit 530 at the same intervals as those of the original blocks. That is, each segment block has the same contents as the corresponding original block.

The block editing unit 542 generates edited content on the basis of edited block(s) having the same contents as corresponding segment block(s) or edited block(s) obtained by editing corresponding segment block(s). Then, the block editing unit 542 outputs the generated edited content to the name deciding unit 550.

The name deciding unit 550 decides upon a name of the edited content input from the content editing unit 540 and names of the edited blocks constituting the edited content. Note that in the case where an edited block has the same contents as its original block, the name deciding unit 550 decides that the block name of the original block is to be the block name of the edited block. The case where an edited block has the same contents as its original block is the case where a segment block is used as the edited block without any processing. The name deciding unit 550 also generates index information of the edited content. Then, the name deciding unit 550 stores the edited content and the generated index information of the edited content in the edited content storage unit 560.

The edited content storage unit 560 stores therein the edited content (that is, edited blocks) and the index information of the edited content that have been input thereto.

The publishing unit 570 publishes, via the communication unit 510 over the CCN network, the index information of the edited content and the edited blocks that are stored in the edited content storage unit 560.

Although not illustrated, the editing terminal 500 includes operation interfaces such as a keyboard, a mouse, and a touchscreen; and a display interface such as a liquid crystal display or a plasma display.

The editing terminal 500 configured in this manner is capable of publishing, in the case where an edited block has the same contents as its original block, the edited block and index information of edited content by using the name of the original block.

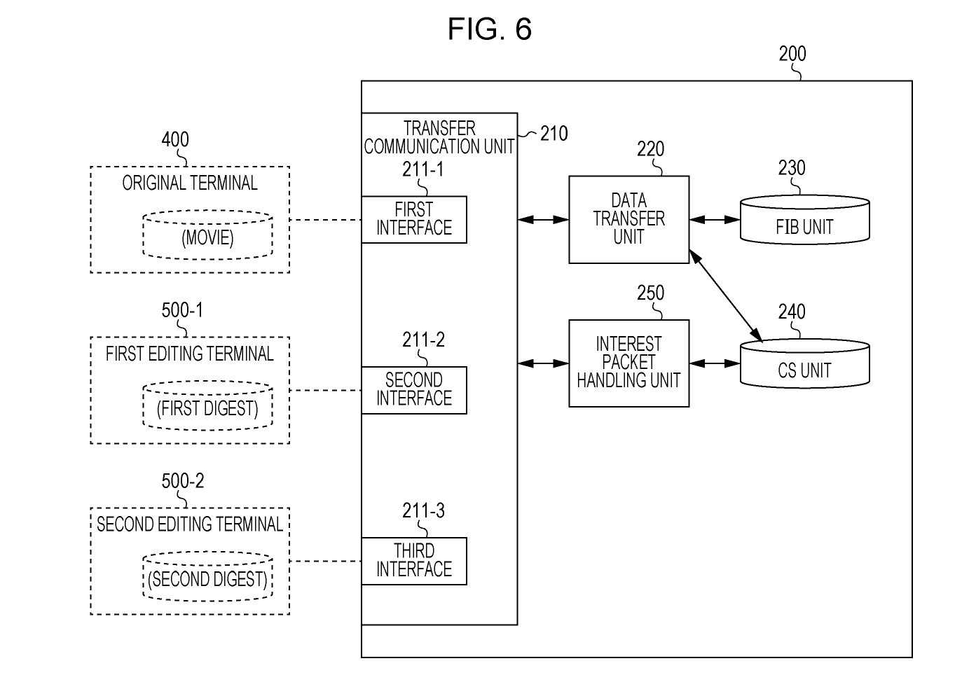

FIG. 6 is a block diagram illustrating an example of a configuration of the transfer terminal 200.

Referring to FIG. 6, the transfer terminal 200 includes a transfer communication unit 210, a data transfer unit 220, an FIB unit 230, a content store (CS) unit 240, and an interest packet handling unit 250.

The transfer communication unit 210 establishes a connection to the CCN network, and performs communication with other terminals. The transfer communication unit 210 includes first to third interfaces 211-1 to 211-3 which are virtual interfaces (“faces” described in Derek Kulinsk et al., “NDNVideo: Random-access Live and Pre-recorded Streaming using NDN”, Technical Report NDN-0007, 2012). Identification numbers 1 to 3 are set for the first to third interfaces 211-1 to 211-3, respectively. For example, the first interface 211-1 is connected to the original terminal 400, the second interface 211-2 to the first editing terminal 500-1, and the third interface 211-3 to the second editing terminal 500-2.

The data transfer unit 220 accepts the index information and the block published for the transfer terminal 200 via the transfer communication unit 210, and sets the properties of the first to third interfaces 211-1 and 211-3 in the FIB unit 230. Such properties are information that defines from which interface an interest packet and data are to be transmitted upon receipt of the interest packet or the data. Then, based on the contents set in the FIB unit 230, the data transfer unit 220 transfers the interest packet and the data via the transfer communication unit 210 between the transmission source of the interest packet and a partner that stores data specified by the interest packet.

Also, every time the data transfer unit 220 transfers data, the data transfer unit 220 causes the CS unit 240 (data cache unit) to store a duplicate of the data (data packet storing the data) therein. Such data includes index information of original content, original blocks, index information of edited content, and edited blocks.

Upon receipt of an interest packet specifying a content name of edited content after index information of the edited content has been stored in the CS unit 240, the interest packet handling unit 250 returns a duplicate of the index information of the edited content. Also, upon receipt of an interest packet specifying a block name of an edited block after the edited block has been stored in the CS unit 240, the interest packet handling unit 250 returns a duplicate of the edited block. The interest packet handling unit 250 performs reception of these interest packets and returning of data via the transfer communication unit 210.

Although not illustrated, the transfer terminal 200 includes a pending interest table (PIT). The data transfer unit 220 prevents the same interest packet from being transferred to upstream multiple times, by managing and referring to the PIT.

The transfer terminal 200 configured in this manner can implement the data cache function and the interest-packet response function over CCN.

Although not illustrated, the editing terminal 500 and the transfer terminal 200 each include a CPU, a storage medium such as a ROM storing a control program, a work memory such as a RAM, and a communication circuit. In this case, functions of the above-described units are implemented as a result of the CPU executing the control program.

Also, the original terminal 400 has a configuration similar to that of the editing terminal 500, for example. However, the original terminal 400 generates original blocks by dividing real-time stream data of original content in a certain size along a time axis with reference to a certain time along the time axis. Then, the original terminal 400 publishes the original blocks and index information of the original content.

In the following description, the time axis of real-time stream data of original content is referred to as an “original time axis”. The certain time used as a reference when the original content is divided to generate original blocks is hereinafter referred to as a “division reference time”. The size used when the original content is divided to generate original blocks is referred to as an “original block size”.

### <Operations Performed by Individual Terminals>

Next, operations performed by the editing terminal 500 and the transfer terminal 200 will be described.

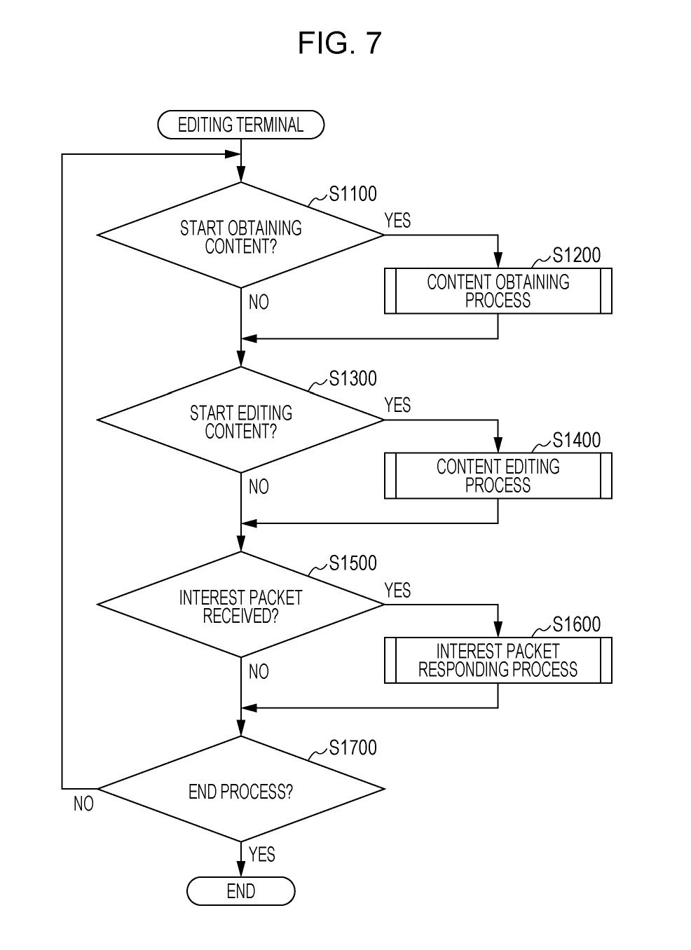

FIG. 7 is a flowchart illustrating an example of an operation performed by the editing terminal 500.

First, in step S1100, the original content obtaining unit 520 determines whether or not an instruction to obtain original content has been given through a user operation or the like. If the original content obtaining unit 520 determines that an instruction to obtain original content has been given (S1100: YES), the process proceeds to step S1200. If the original content obtaining unit 520 determines that an instruction to obtain original content has not been given (S1100: NO), the process proceeds to step S1300 which will be described later.

In step S1200, the original content obtaining unit 520 performs a content obtaining process which is a process for obtaining original content. Then, the process proceeds to step S1300 which will be described later.

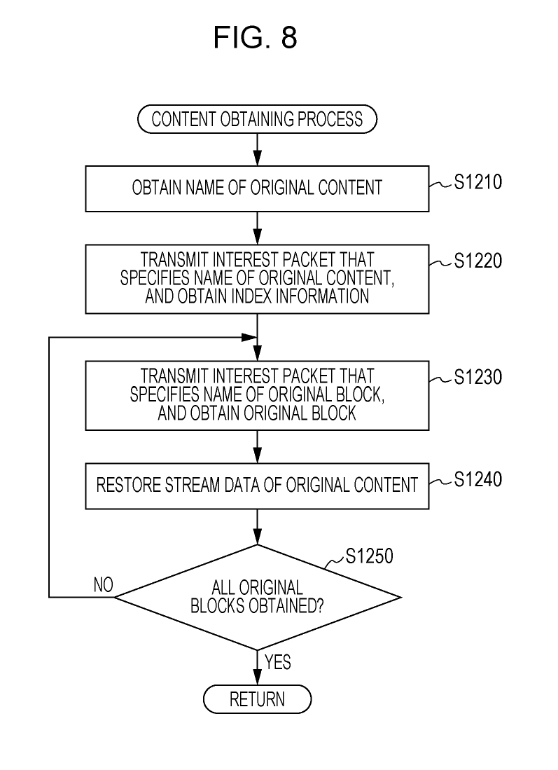

FIG. 8 is a flowchart illustrating an example of the content obtaining process.

First, in step S1210, the original content obtaining unit 520 obtains a content name of the original content.

Note that a unique service name is preset for the original terminal 400. For example, a service name “/edit_service/4k_movie/title_A/original” is set for the original terminal 400. This service name is used as a content name of the original content. Specifically, this service name serves as the prefix portion 621 (see FIG. 4) of the original content namespace 620. Accordingly, for example, the original content obtaining unit 520 obtains “/edit_service/4k_movie/title_A/original” as the content name of the original content.

Then, in step S1220, the original content obtaining unit 520 generates an interest packet specifying the content name of the original content, and transmits the interest packet over the CCN network. As a response to this interest packet, the original content obtaining unit 520 obtains index information of the original content from the original terminal 400.

For example, the original content obtaining unit 520 transmits an interest packet including a namespace “/edit_service/4k_movie/title_A/original/index/”. Specifically, the original content obtaining unit 520 issues an interest packet specifying “/edit_service/4k_movie/title_A/original/index/time00_{—}00_{—}01”. Then, as a response to the interest packet, the original content obtaining unit 520 obtains a combination of a block name “HASH1” and reproduction time information, that is, index information of the original content. Note that the reproduction time information may represent a reproduction time stamped based on a specific frequency, such as a timestamp of an RTP packet, or a relative time difference from the reproduction start time.

Subsequently, in step S1230, based on the obtained index information, the original content obtaining unit 520 generates an interest packet specifying a block name of an original block, and transmits the interest packet over the CCN network. As a response to this interest packet, the original content obtaining unit 520 obtains the original block from the original terminal 400.

For example, the original content obtaining unit 520 transmits an interest packet specifying a namespace “/edit_service/4k_movie/title_A/original/hash/HASH1”. Then, the original content obtaining unit 520 obtains the entity of the original block stored in the namespace.

Then, in step S1240, the original content obtaining unit 520 restores real-time stream data of the original content on the basis of the obtained original blocks. Specifically, the original content obtaining unit 520 rearranges and concatenates the plurality of obtained original blocks in the reproduction order. This is performed because an order in which blocks arrive does not necessarily match the reproduction order in CCN. Note that such restoration may be performed every time the original block is stored in the original content storage unit 530 or after all original blocks have been stored. Also, the reproduction order can be obtained from additional information regarding original block reproduction time described above, for example.

Then, in step S1250, the original content obtaining unit 520 determines whether or not all original blocks constituting the original content have been obtained. If the original content obtaining unit 520 determines that three is an original block that has not been obtained (S1250: NO), the process returns to step S1230 in which the original content obtaining unit 520 obtains the original block that has not been obtained. Also, if the original content obtaining unit 520 determines that all original blocks have been obtained (S1250: YES), the process returns to the flowchart of FIG. 7.

For example, original blocks having block names “/edit_service/4k_movie/title_A/original/hash/HASH1”, “/edit_service/4k_movie/title_A/original/hash/HASH2”, . . . are returned from the original terminal 400. Also, prior to this, index information in which block names of the original blocks, positions of the original blocks within the original content, and the content name “/edit_service/4k_movie/title_A/original/” of the original content are associated with one another is returned from the original terminal 400. As a result, these original blocks and the index information are cached in individual locations (for example, the transfer terminals 200) over the CCN network.

Also, in the original content storage unit 530, data obtained by concatenating a plurality of original blocks corresponding to the block names “/edit_service/4k_movie/title_A/original/hash/HASH1”, “/edit_service/4k_movie/title_A/original/hash/HASH2”, . . . is stored as the original content.

In step S1300 of FIG. 7, the content editing unit 540 determines whether or not an instruction to start editing the original content has been given through a user operation or the like. If the content editing unit 540 determines that an instruction to start editing the original content has been given (S1300: YES), the process proceeds to step S1400. If the content editing unit 540 determines that an instruction to start editing the original content has not been given (S1300: NO), the process proceeds to step S1500 which will be described later.

In step S1400, the content editing unit 540 performs a content editing process in which the original content is edited. Then, the process proceeds to step S1500 which will be described later.

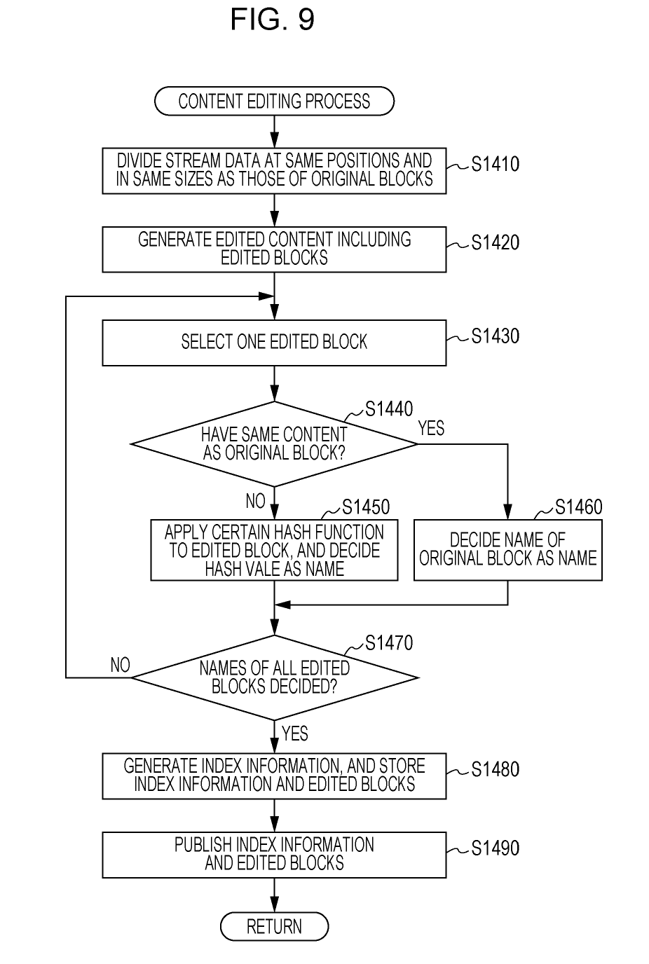

FIG. 9 is a flowchart illustrating an example of the content editing process.

First, in step S1410, the block size dividing unit 541 divides real-time stream data of the original content in the original block size (variable Bs) along the original time axis with reference to the above-described division reference time, and obtains segment blocks (BLKContent).

As the division reference time, for example, the start time along the original time axis, that is, the start position of the real-time stream data (earlier reproduction start time of the start of the video stream and the start of the audio stream) can be adopted. Alternatively, as the division reference time, another specific reproduction time such as time at which a specific marker is inserted or a position of data received at a specific time which is determined using, as a reference time, time based on a global positioning system (GPS) (not illustrated) mounted in the editing terminal 500 may be adopted.

As the original block size, for example, a frame length of an Ethernet packet such as 1500 bytes, or a maximum transmission unit (MTU) size used in a virtual private network (VPN) such as 1280 bytes may be adopted.

The block size dividing unit 541 may use the division reference time and the original block size that are distributed in advance as default values of the communications system 100. Alternatively, the block size dividing unit 541 may obtain the division reference time and the original block size from metadata of the original content every time the original content is obtained.

By obtaining segment blocks using the division reference time and the original block size in this manner, contents of each segment block can be made identical to contents of the corresponding original block.

Note that content generally includes real-time stream data and metadata. Accordingly, the block size dividing unit 541 may perform a process for separating the real-time stream data and the metadata from each other.

Then, in step S1420, the block editing unit 542 generates edited blocks from the segment blocks, and generates edited content.

The block editing unit 542 may generate either an edited block having the same contents as the corresponding segment block or an edited block obtained by editing the corresponding segment block.

The block editing unit 542 generates and displays, for example, an editing operation window that allows a user of the editing terminal 500 to select segment blocks to be included in edited content or to edit video/audio of the segment blocks. The editing operation window includes, for example, a function for presenting an editing point, a function for marking a position serving as a digest target, and a function for obtaining target data to be edited from the original content.

Types of editing performed on segment blocks include, for example, changing the color of video, insertion of characters as overlay, superimposition of interpretation by a narrator, video processing and audio processing.

As a result of the user operation performed on such an editing operation window, for example, edited content is generated in which edited block(s) having the same contents as the corresponding original block(s) and edited block(s) having different contents from the corresponding original block(s) are mixed.

Note that a unique service name is preset for the editing terminal 500. For example, a service name “/edit_service/4k_movie/title_A/ED1” is set for the editing terminal 500. This service name is used as a content name of edited content. Specifically, this service name serves as the prefix portion 641 (see FIG. 4) of the edited content namespace 640.

Then, in step S1430, the name deciding unit 550 selects one edited block from the edited content.

Then, in step S1440, the name deciding unit 550 determines whether or not the selected edited block has the same contents as the corresponding original block. Note that such determination may be made on the basis of whether or not any change is made in the segment block by the content editing unit 540, for example. If the name deciding unit 550 determines that the selected edited block does not have the same contents as the corresponding original block (S1440: NO), the process proceeds to step S1450. If the name deciding unit 550 determines that the selected edited block has the same contents as the corresponding original block (S1440: YES), the process proceeds to step S1460.

In step S1450, the name deciding unit 550 decides upon, for the selected edited block, a block name different from the block name of the corresponding original block. Specifically, for example, the name deciding unit 550 decides that a hash value (BKL_HASH) which is obtained by applying a certain hash function to the selected edited block is to be the block name of the selected edited block.

The certain hash function is a hash function that is distributed in advance or known in the communications system 100 and that is used in common by the individual terminals of the communications system 100. Deciding upon the block name using the certain hash function in this manner is advantageous particularly in the case of limiting obtainers of edited content. Such an advantage will be described in detail in a third embodiment of the present disclosure, which will be described later.

For example, suppose that the block name of the original block is “/edit_service/4k_movie/title_A/original/hash/HASH1”. In this case, at least the prefix portion is changed and the block name of the edited block becomes “/edit_service/4k_movie/title_A/ED1/hash/HASH1/”.

On the other hand, in step S1460, the name deciding unit 550 decides that the block name of the selected edited block is to be the same as the block name of the corresponding original block.

For example, suppose that the block name of the original block is “/edit_service/4k_movie/title_A/original/hash/HASH2”. In this case, the block name of the edited block is maintained as “/edit_service/4k_movie/title_A/original/hash/HASH2”. That is, at least the prefix portion changes in the block name of the edited block from the block name of the original block in the related art; however, even the prefix portion is not changed in the second embodiment.

Then, in step S1470, the name deciding unit 550 determines whether or not block names of all the edited blocks constituting the edited content have been decided upon. If the name deciding unit 550 determines that there is an edited block whose block name has not been decided upon (S1470: NO), the process returns to step S1430 in which the name deciding unit 550 selects the edited block whose block name has not been decided upon. If the name deciding unit 550 determines that block names of all the edited blocks have been decided upon (S1470: YES), the process proceeds to step S1480.

In step S1480, the name deciding unit 550 generates index information of the edited content on the basis of positions of the individual edited blocks within the edited content and the names of the edited blocks. Then, the name deciding unit 550 stores the generated index information and the edited content (edited blocks) in the edited content storage unit 560. Note that generation and storage of the index information may be performed by the publishing unit 570.

Subsequently, in step S1490, the publishing unit 570 publishes the edited content and the index information of the edited content that are stored in the edited content storage unit 560 over the CCN network. The process then returns to the flowchart of FIG. 7.

For example, edited blocks having block names “/edit_service/4k_movie/title_A/ED1/hash/HASH1”, “/edit_service/4k_movie/title_A/original/hash/HASH2”, . . . are stored in the edited content storage unit 560. Also, index information in which the block names of these edited blocks, positions of these edited blocks within the edited content, and the content name of the edited content “/edit_service/4k_movie/title_A/ED1/” are associated with one another is stored in the edited content storage unit 560. Then, these index information and edited blocks are published over the CCN network.

In step S1500 of FIG. 7, the publishing unit 570 determines whether or not an interest packet has been received via the CCN network. If the publishing unit 570 determines that an interest packet has been received (S1500: YES), the process proceeds to step S1600. If the publishing unit 570 determines that an interest packet has not been received (S1500: NO), the process proceeds to step S1700 which will be described later.

In step S1600, the publishing unit 570 performs an interest packet responding process which is a process for responding to an interest packet to be responded. Then, the process proceeds to step S1700 which will be described later.

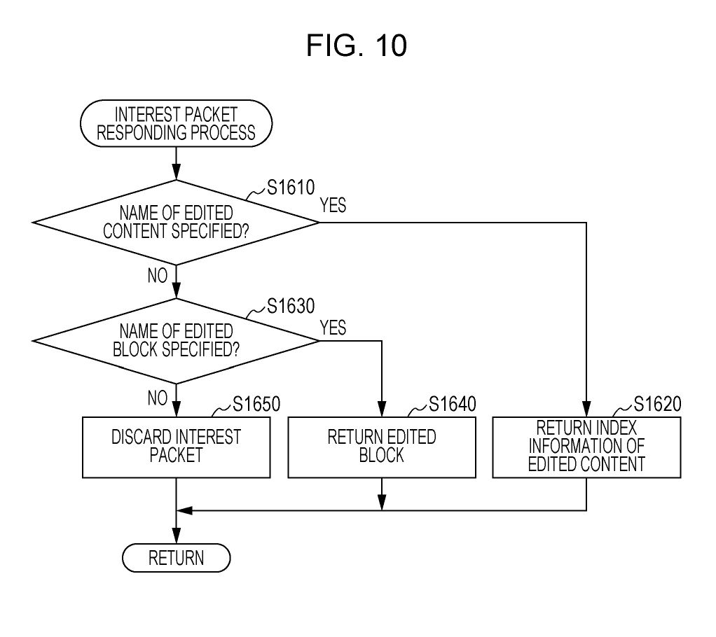

FIG. 10 is a flowchart illustrating an example of the interest packet responding process.

First, in step S1610, the publishing unit 570 determines whether or not the received interest packet specifies the content name of edited content stored in the edited content storage unit 560 (specifically, index information stored in the edited content storage unit 560). If the publishing unit 570 determines that the interest packet specifies the content name (S1610: YES), the process proceeds to step S1620. If the publishing unit 570 determines that the interest packet does not specify the content name (S1610: NO), the process proceeds to step S1630.

In step S1620, the publishing unit 570 reads out index information of the edited content having the content name specified by the interest packet from the edited content storage unit 560. Then, the publishing unit 570 returns the read index information to the transmission source of the interest packet. The process then returns to the flowchart of FIG. 7.

In step S1630, the publishing unit 570 determines whether or not the received interest packet specifies a block name of an edited block stored in the edited content storage unit 560. If the publishing unit 570 determines that the interest packet specifies the block name (S1630: YES), the process proceeds to step S1640. If the publishing unit 570 determines that the interest packet does not specify the block name (S1630: NO), the process proceeds to step S1650.

In step S1640, the publishing unit 570 reads out the edited block having the block name specified by the interest packet from the edited content storage unit 560. Then, the publishing unit 570 returns the read edited block to the transmission source of the interest packet. The process then returns to the flowchart of FIG. 7.

In step S1650, the publishing unit 570 discards the received interest packet. The process then returns to the flowchart of FIG. 7.

For example, edited blocks having the block names “/edit_service/4k_movie/title_A/ED1/hash/HASH1”, “/edit_service/4k_movie/title_A/original/hash/HASH2”, . . . are returned to the transmission source of the interest packet. Also, prior to this, index information in which block names of these edited blocks, positions of these edited blocks within the edited content, and the content name of the edited content “/edit_service/4k_movie/title_A/ED1/” are associated with one another is returned to the transmission source of the interest packet. As a result, these edited blocks and index information are cached at individual locations (for example, the transfer terminals 200) over the CCN network.

As described above, the original blocks have already been cached over the CCN network at the time when the editing terminal 500 obtains the original content. Accordingly, there are cases where an interest packet specifying a block name of an edited block having the same contents as its original block is processed by the transfer terminal 200 in which the original block is cached, and does not reach the editing terminal 500 as described later.

Through such an operation, in the case where an edited block has the same contents as its original block, the editing terminal 500 can publish the edited block and index information of edited content using the name of the corresponding original block.

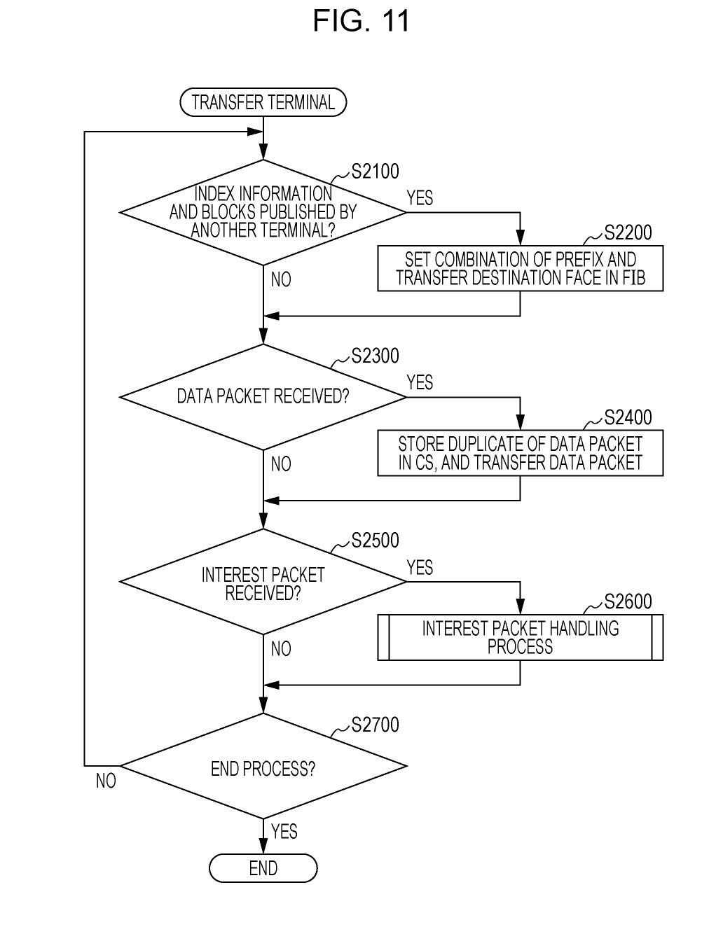

FIG. 11 is a flowchart illustrating an example of an operation performed by the transfer terminal 200.

First, in step S2100, the data transfer unit 220 determines whether or not index information and blocks of content (original content or edited content) have been published by another terminal (the original terminal 400 or the editing terminal 500). If the data transfer unit 220 determines that the index information and the blocks have been published (S2100: YES), the process proceeds to step S2200. If the data transfer unit 220 determines that the index information and the blocks have not been published (S2100: NO), the process proceeds to step S2300 which will be described later.

In step S2200, the data transfer unit 220 sets a combination of a prefix of the content name of the published content and a transfer destination face in the FIB unit 230. The transfer destination face is, for example, a virtual interface that has received a notification regarding the prefix of the content name.

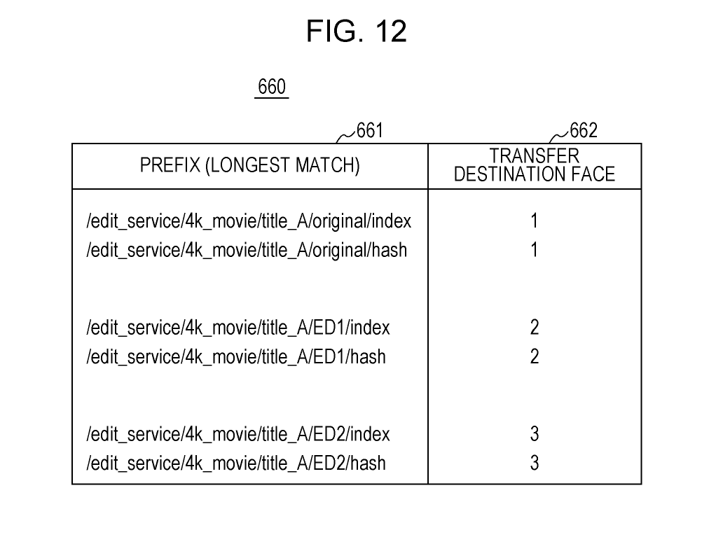

FIG. 12 is a diagram illustrating an example of contents of the FIB unit 230.

As illustrated in FIG. 12, an FIB 660 set in the FIB unit 230 describes a namespace 661 called a prefix longest match and identification information 662 of the transfer destination face in association with each other. Note that the prefix longest match indicates a part having the longest forward matching range.

The data transfer unit 220 associates the identification information 662 of the virtual interface with the namespace 661 obtained by appending “/index” to the informed prefix and the namespace 661 obtained by appending “/hash” to the informed prefix. Note that these character strings may be appended by the publisher.

For example, the identification information 662 “2” is associated with the namespace 661 “/edit_service/4k_movie/title_A/ED1/hash”. This indicates that upon receipt of an interest packet specifying a namespace “/edit_service/4k_movie/title_A/ED1/hash”, the interest packet is to be transmitted (transferred) from the second interface 211-2.

In step S2300 of FIG. 11, the data transfer unit 220 determines whether or not a data packet has been received. If the data transfer unit 220 determines that a data packet has been received (S2300: YES), the process proceeds to step S2400. If the data transfer unit 220 determines that a data packet has not been received (S2300: NO), the process proceeds to step S2500 which will be described later.

In step S2400, the data transfer unit 220 obtains, from the data packet, the data and the name of the data that are stored in the data packet. Then, the data transfer unit 220 stores a duplicate of the data packet and sets a combination of the obtained data and the name of the data in the CS unit 240. Then, the data transfer unit 220 transfers the data packet to the destination.

The data stored in the data packet includes index information and block(s). Accordingly, the data transfer unit 220 obtains, for example, index information and original blocks of the original content, and index information and edited blocks of the edited content, and caches them in the CS unit 240.

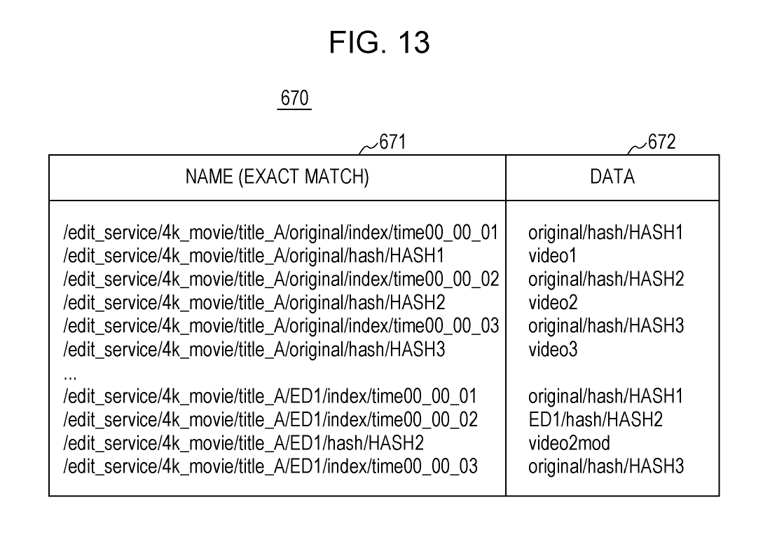

FIG. 13 is a diagram illustrating an example of contents of the CS unit 240.

As illustrated in FIG. 13, a CS 670 set in the CS unit 240 describes a namespace 671 called a name exact match and data 672 in association with each other.

For example, data 672 “original/hash/HASH1” is associated with the namespace 671 “/edit_service/4k_movie/title_A/original/index/time00_{—}00_{—}01”.

The namespace “/edit_service/4k_movie/title_A/original/index/time00_{—}00_{—}01” indicates a position of time 01 along the time axis of original content having the content name “edit_service/4k_movie/title_A/original/”. Also, the data “original/hash/HASH1” indicates a block name “/edit_service/4k_movie/title_A/original/hash/HASH1”.

That is, the above-described association is equivalent to index information in which the content name, the position of the block, and the block name are associated with one other.

Also, for example, the data 672 “video1” is associated with the namespace 671 “/edit_service/4k_movie/title_A/original/hash/HASH1”.

“/edit_service/4k_movie/title_A/original/hash/HASH1” is a block name of the body of the data “video1”.

That is, the above-described association is equivalent to a block itself.

Also, referring to FIG. 13, the data 672 “original/hash/HASH1” is associated with the namespace 671 “/edit_service/4k_movie/title_A/ED1/index/time00_{—}00_{—}01”. This indicates that the same block name as that of the original block is assigned to the edited block. That is, it is indicated that when edited content is obtained, a block name of the corresponding original block can be referred to and the original block can be obtained.

In step S2500 of FIG. 11, the interest packet handling unit 250 determines whether or not an interest packet has been received via the CCN network. If the interest packet handling unit 250 determines that the interest packet has been received (S2500: YES), the process proceeds to step S2600. Also, if the interest packet handling unit 250 determines that the interest packet has not been received (S2500: NO), the process proceeds to step S2700 which will be described later.

In step S2600, the interest packet handling unit 250 performs an interest packet handling process which is a process for handling an interest packet. Then, the process proceeds to step S2700 which will be described later.

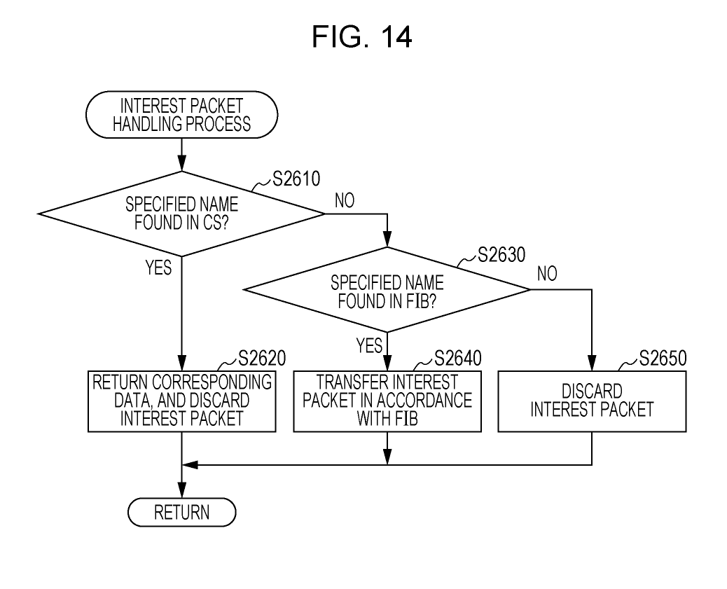

FIG. 14 is a flowchart illustrating an example of the interest packet handling process.

First, in step S2610, the interest packet handling unit 250 determines whether or not the name specified by the received interest packet is found in the CS unit 240 (see FIG. 13). If the interest packet handling unit 250 determines that the name specified by the received interest packet is found in the CS unit 240 (S2610: YES), the process proceeds to step S2620. If the interest packet handling unit 250 determines that the name specified by the received interest packet is not found in the CS unit 240 (S2610: NO), the process proceeds to step S2630.

In step S2620, the interest packet handling unit 250 obtains, from the CS unit 240, data corresponding to the name specified by the interest packet, and returns the data to the transmission source of the interest packet. Then, the interest packet handling unit 250 discards the received interest packet. The process then returns to the flowchart of FIG. 11.

In step S2630, the interest packet handling unit 250 determines whether or not the prefix of the name specified by the received interest packet is found in the FIB unit 230 (see FIG. 12). If the interest packet handling unit 250 determines that the prefix of the name specified by the interest packet is found in the FIB unit 230 (S2630: YES), the process proceeds to step S2640. If the interest packet handling unit 250 determines that the prefix of the name specified by the interest packet is not found in the FIB unit 230 (S2630: NO), the process proceeds to step S2650.

In step S2640, the interest packet handling unit 250 transfers the received interest packet in accordance with contents set in the FIB unit 230. The process then returns to the flowchart of FIG. 11.

In step S2650, the interest packet handling unit 250 discards the received interest packet. The process then returns to the flowchart of FIG. 11.

In step S2700 of FIG. 11, the interest packet handling unit 250 determines whether or not an instruction to end the process has been given by a management server (not illustrated) of the communications system 100. If the interest packet handling unit 250 determines that an instruction to end the process has not been given (S2700: NO), the process returns to step S2100. If the interest packet handling unit 250 determines that an instruction to end the process has been given (S2700: YES), the sequence of the process ends.

For example, suppose that the FIB 660 illustrated in FIG. 12 and the CS 670 illustrated in FIG. 13 are set in the transfer terminal 200.

Suppose that the transfer terminal 200 has received an interest packet specifying a namespace “/edit_service/4k_movie/title_A/ED2/index/ALL” in this state.

This namespace is not found in the CS 670 but is found in the FIB 660, and is associated with the transfer destination face “3”. Accordingly, the transfer terminal 200 transmits (transfers) the interest packet from the third interface 211-3.

Also, suppose that the transfer terminal 200 has received an interest packet specifying a namespace “/edit_service/4k_movie/title_A/original/index/ALL”.

This namespace is found in the CS 670 and is associated with block names such as “original/hash/HASH1” for individual reproduction times. Accordingly, the transfer terminal 200 obtains these associations as index information, and returns the index information to the transmission source of the interest packet.

Also, suppose that the transfer terminal 200 has received an interest packet specifying a namespace “/edit_service/4k_movie/title_A/original/hash/HASH1”.

This namespace is found in the CS 670 and is associated with data “video1”. Accordingly, the transfer terminal 200 obtains such data (block) and returns the data to the transmission source of the interest packet.

Also, suppose that the transfer terminal 200 has received an interest packet specifying a namespace “/edit_service/4k_movie/title_A/ED3/index/ALL”.

This namespace is found neither in the CS 670 nor in the FIB 660. Accordingly, the transfer terminal 200 discards the received interest packet.

Through such an operation, the transfer terminal 200 can implement the data cache function and the interest-packet response function over CCN.

Note that the transfer terminal 200 (and the editing terminal 500) may first return information representing the reproduction time of each block for the namespace “index/ALL”, and may then return, in response to acceptance of specified reproduction time, information representing the corresponding block name. That is, the transfer terminal 200 may perform a process of returning the index information in two steps.

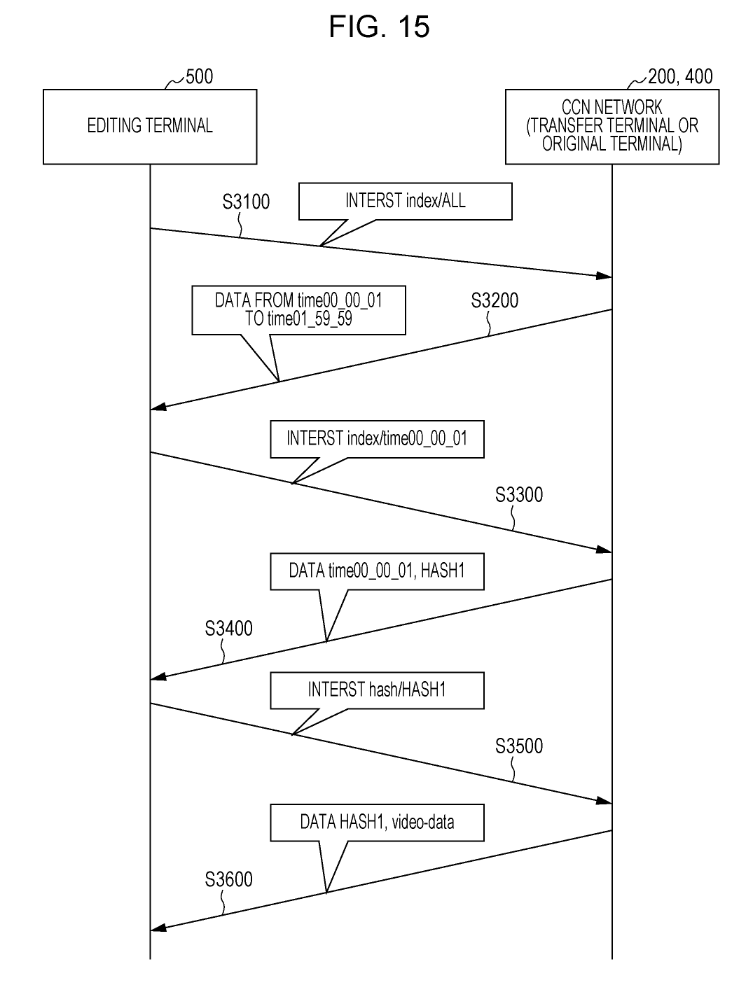

FIG. 15 is a sequence diagram illustrating an example of a flow of how packets are exchanged between the editing terminal 500 and the CCN network in the case where the process of returning the index information is performed in two steps.

First, the editing terminal 500 transmits an interest packet specifying a namespace “index/ALL” of content via the CCN network (S3100). In response to this interest packet, a partner (the transfer terminal 200 or the original terminal 400) that is on the CCN network and in which corresponding index information has been cached returns a list of reproduction times of individual blocks “time00_{—}00_{—}01” to “time01_{—}59_{—}59” (S3200).

The editing terminal 500 that has received the list of reproduction times transmits an interest packet specifying a namespace of a reproduction time such as “index/time00_{—}00_{—}01” via the CCN network (S3300). In response to this interest packet, a partner in which the corresponding index information has been cached returns “HASH1” which is a block name of a block corresponding to the reproduction time (S3400). Note that this partner is not necessarily the same as the partner that has returned the list of reproduction times.

The editing terminal 500 that has received the block name transmits an interest packet specifying a block name “hash/HASH1” via the CCN network (S3500). In response to this interest packet, a partner in which the corresponding block has been cached returns “video1” which is a block corresponding to the block name (S3600). Note that this partner is not necessarily the same as the partner that has returned the list of reproduction times or the partner that has returned the block name.

By performing transmission of data packets corresponding to the index information and the block name separately in two steps in this manner, edited content in which original block(s) and edited block(s) are mixed can be reproduced.

Now, an example of a circumstance in which cached original content is utilized for distribution of edited content in the second embodiment will be described.

Referring to FIG. 2, suppose that the first editing terminal 500-1 obtains a movie serving as original content from the original terminal 400, and generates a first digest serving as edited content in which original blocks are concatenated without any processing; and then, the third editing terminal 500-3 is attempting to obtain this first digest.

In this case, the movie has been transmitted via the first transfer terminal 200-1 and the second transfer terminal 200-2. Thus, the original blocks are stored in the second transfer terminal 200-2. Edited blocks included in the first digest are each assigned the same name as that of the corresponding original block.

Therefore, for an interest packet specifying a name of an edited block included in the first digest, a cache in the second transfer terminal 200-2 is retrieved. In this way, the third editing terminal 500-3 can obtain the edited block from the second transfer terminal 200-2 located closer to the third editing terminal 500-3 than the first editing terminal 500-1, instead of from the first editing terminal 500-1.

Also, suppose that the fourth editing terminal 500-4 is attempting to obtain the movie serving as the original content thereafter.

In this case, the first digest has been transmitted via the second transfer terminal 200-2 and the third transfer terminal 200-3. Accordingly, the edited blocks each having the same contents as the corresponding original block are stored in the third transfer terminal 200-3. Also, the edited blocks included in the first digest are each assigned the same name as the corresponding original block.

Therefore, for at least some of interest packets specifying the name of the original block contained in the movie, a cache in the third transfer terminal 200-3 is retrieved. In this way, the fourth editing terminal 500-4 can obtain the original block from the third transfer terminal 200-3 located closer to the fourth editing terminal 500-4 than the original terminal 400, instead of from the original terminal 400.

### ADVANTAGES

As described above, in the communications system 100 according to the second embodiment, in the case where an edited block has the same contents as its original content, the editing terminal 500 publishes the edited block and index information of edited content by using the name of the original block. With this configuration, when the edited block is searched for based on the index information of the edited content, a cached original block having the same contents as the edited content is retrieved and this cached original block can be obtained. Accordingly, the communications system 100 according to the second embodiment enables utilization of cached original content for distribution of edited content.

Such a communications system 100 is suitable for a so-called clowd editing system in which multiple editors edit video/audio stream data via a communications network. That is, the communications system 100 can distribute a processing load related to content editing over a network.

Note that a limitation may be imposed on obtaining of content such that only a publisher of original content (movie) and other editors having a right to edit the original content can view edited content (digests) published by the editing terminals 500.

In this case, for example, the editing terminal 500 publishes encrypted edited content (index information or a block) and separately causes the publisher or other editors of the original content to obtain a decryption key. Examples of an adaptable method for transmitting/receiving the decryption key include transmission by email encrypted by certain encryption software, transmission/reception using an offline storage medium, and transmission/reception via a server made accessible only to specific members.

In the case where a limitation for allowing specific user(s) to view content in this manner is desired, the communications system 100 desirably distributes and manages keys used for encrypting content and decrypting the encrypted content as appropriate. Note that the communications system 100 may manage the entire CCN network as a closed network, and may permit all people who can access the closed network to access all pieces of content.

### Third Embodiment

A third embodiment of the present disclosure is an example of a specific aspect of the present disclosure of the case where data that has been duplicated for private use is compressed and held over the entire network while limiting obtainers of edited content.

### <Overview of Communications System>

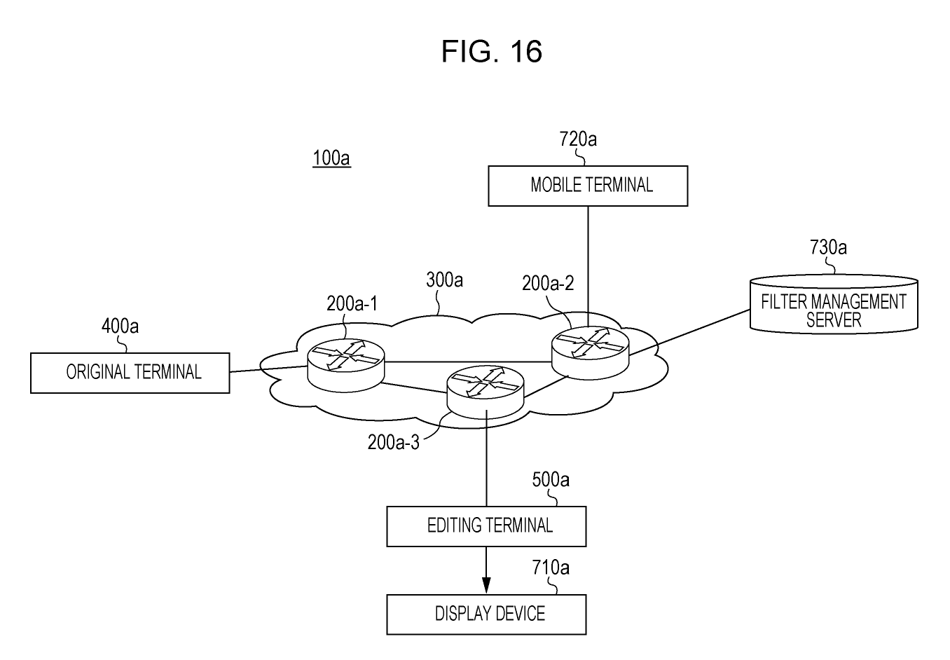

FIG. 16 is a system configuration diagram illustrating an example of a configuration of a communications system according to the third embodiment, and corresponds to FIG. 2 of the second embodiment. Components similar to those of FIG. 2 are denoted by the same references, and a description thereof is omitted.

Referring to FIG. 16, a communications system 100a includes a communications network 300a, an original terminal 400a, and an editing terminal 500a. Over the communications network 300a, first to third transfer terminals 200a-1 to 200a-3 are located. The original terminal 400a and the editing terminal 500a are connected to the communications network 300a. A display device 710a is connected to the editing terminal 500a. Also, a mobile terminal 720a and a filter management server 730a are connected to the communications network 300a. Note that the communications system 100a forms a CCN network as in the second embodiment.

The original terminal 400a has a function for broadcasting video/audio content over the CCN network at a determined time. The original terminal 400a is, for example, a server at a so-called network broadcasting station.

The editing terminal 500a has a function for obtaining, recording, and reproducing video/audio content that is broadcast at a determined time by the original terminal 400a. The editing terminal 500a is, for example, a set top box (STB) for receiving broadcast content of the network broadcasting station and outputs the received broadcast content to a television apparatus.

Note that it is assumed that a user of the editing terminal 500a has a right to obtain video/audio content broadcast by the original terminal 400a and to duplicate it for private use (hereinafter, this right is referred to as a “content use right”). The content use right is a right to obtain, store, and reproduce original content and edited content generated from this original content.

The display device 710a is a device that displays an image and outputs sound. The display device 710a is, for example, a television device.

The mobile terminal 720a is a device that obtains video/audio content recorded by the editing terminal 500a from the editing terminal 500a via the communications network 300a, and reproduces the video/audio content. The mobile terminal 720a is, for example, a smartphone or tablet terminal used by a user having the content use right, for example, the user of the editing terminal 500a.

The filter management server 730a is a device that dynamically inserts a filter that allows only the mobile terminal 720a to obtain video/audio content recorded by the editing terminal 500a, at the first to third transfer terminals 200a-1 to 200a-3. Details about this filter will be described later.

The first to third transfer terminals 200a-1 to 200a-3 each have the data cache function and the interest-packet response function over CCN like the transfer terminals 200 according to the second embodiment. In addition to the data cache function and the interest-packet response function, the first to third transfer terminals 200a-1 to 200a-3 each limit the interest-packet response function using a filter set by the filter management server 730a.

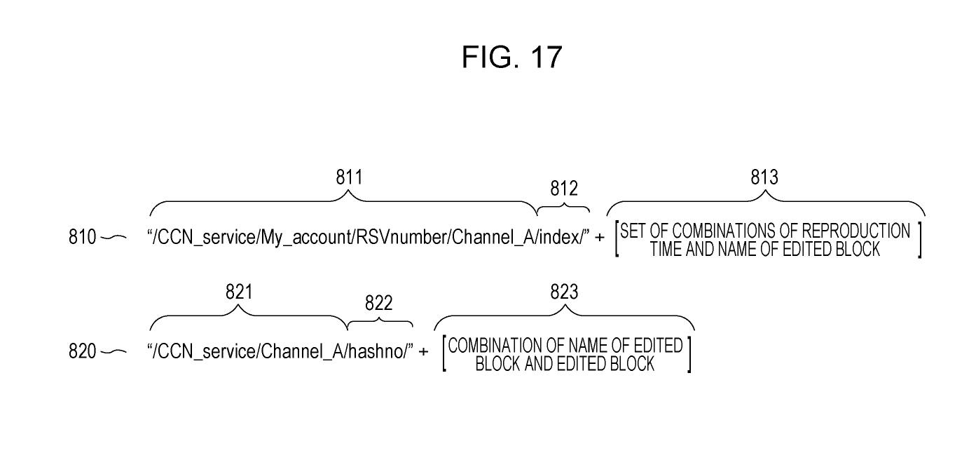

FIG. 17 is a diagram illustrating a design example of edited content namespaces used in the communications system 100a.

For example, an edited content namespace 810 and an edited block namespace 820 illustrated in FIG. 17 are set for the communications system 100a.

The edited content namespace 810 includes a prefix portion 811, a data portion 812, and a data portion 813. Also, the edited block namespace 820 includes a prefix portion 821, a data portion 822, and a data portion 823. Note that the prefix portion 821 of the edited block namespace 820 is different from the prefix portion 811 of the edited content namespace 810.

Such a communications system 100a allows a user having the content use right to obtain and view edited content at a location different from the location of the editing terminal 500a that stores the edited content. Also, the communications system 100a can limit users who can obtain the edited content to user(s) having the content use right.

However, when this limitation is implemented by filtering on both an interest packet for index information and an interest packet for a block, for example, such implementation makes the processing complicated.

On the other hand, if the block name is difficult to predict, users who can obtain the edited content can be limited to user(s) having the content use right by just imposing a limitation on obtaining of index information.

Also, if a configuration is made such that the same block name is assigned to blocks having the same contents, a cache hit rate of the block can be improved.

Further, if a probability of the original block and the edited block having the same contents is increased, the cache hit rate of the block can be further improved.

Accordingly, in the communications system 100a according to the third embodiment, real-time stream data of original content is divided and block names are decided upon in accordance with the same rules as those of the second embodiment in the original terminal 400a and all the editing terminals 500a.

### <Block Name Deciding Method>

Here, details about the block name deciding method will be described.

A certain hash function used to decide upon a block name is a hash function that is selected taking the length of the stream data into consideration such that a possibility that block names coincide with one another becomes sufficiently small.

For example, the certain hash function desirably has a property of shortening the data length, such as calculating a 128-byte hash value from a 1500-byte block. The length of the hash value may be variable in accordance with the length of the stream data; however, information indicating which hash function has been used needs to be separately shared among all the editing terminals 500a. Such information sharing is performed using meta-information of the stream data, for example.

Specifically, the original terminal 400a and the editing terminals 500a decide upon a block name of a block and publish index information and the block in the following procedure, for example. No that such a procedure is obviously applicable to the second embodiment.

The original terminal 400a and the editing terminals 500a store a hash value (variable BLK_HASH) that has been calculated as the block name in a database (not illustrated) in the memory. At this time, if the same hash value (BKL_HASH) has already been stored, the original terminal 400a and the editing terminals 500a change a flag (DUP) in the memory to “1”.

The original terminal 400a and the editing terminals 500a convert the calculated hash value (BKL_HASH) into a character string, and store the character string as a block name (BLK_name). At this time, if the flag (DUP) is “1”, the original terminal 400a and the editing terminals 500a change the block name to be “DUP/”+[n]+[_Blk_name], where [n] represents a character string converted from an integer indicating the number of times the same block name (BLK_name) appears. In this way, a plurality of blocks having the same contents can be handled so that they are distinguished from one another.

The original terminal 400a and the editing terminals 500a decide upon a recording format of a combination of the decided block name and the reproduction time, and publish the combination over the CCN network. Specifically, the original terminal 400a and the editing terminals 500a store the block name (Blk_name) as data corresponding to a name in a formant of “time”+[reproduction time], which is a component of the “index/” namespace. Then, the original terminal 400a and the editing terminals 500a prepare a response to the “index/ALL” namespace and a response to the “index/LATEST” namespace.

Note that [reproduction time] is a character string representing the reproduction time of the real-time stream data, and is, for example, a character string in a formant of hour: minute: second: millisecond. As a response to an interest packet specifying “ALL”, a list of all names of “time”+[reproduction time] stored in the space of “index/” is returned as described above. Also, as a response to an interest packet specifying “index/LATEST”, a name corresponding to the maximum value of [reproduction time] is returned as described above. Note that a special flag for preventing caching in the transfer terminals 200a may be added to responses regarding special names, such as ALL and LATEST, before the responses are transmitted. Then, each transfer terminal (router) 200a may interpret the flag, and prevent caching. Alternatively, as implementation references of the transfer terminals 200a, a rule may be set such that responses regarding special names are not to be cached.

### <Configurations and Operations of Individual Apparatuses>

Next, configurations and operations of the editing terminal 500a and the transfer terminal 200a will be described.

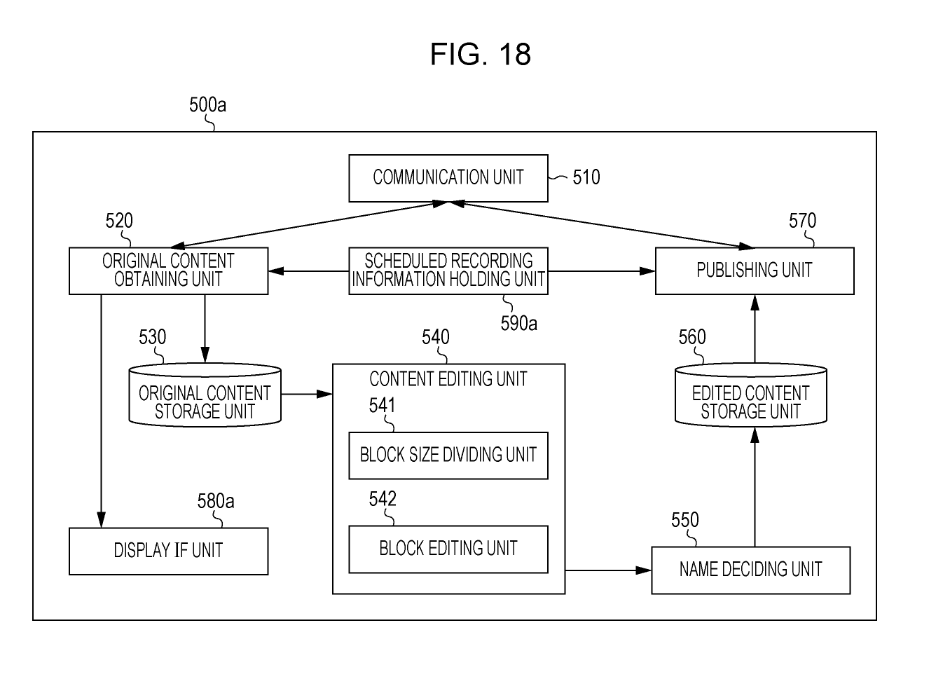

FIG. 18 is a block diagram illustrating an example of a configuration of the editing terminal 500a, and corresponds to FIG. 5 of the second embodiment. Components similar to those of FIG. 5 are denoted by the same references, and a description thereof is omitted.

Referring to FIG. 18, the editing terminal 500a includes a display interface (IF) unit 580a and a scheduled recording information storage unit 590a in addition to the configuration illustrated in FIG. 5. Note that in the third embodiment, the editing terminal 500a does not necessarily perform editing so that edited content have contents different from those of its original content. For example, edited content may have completely the same contents as its original content.

In this case, the editing terminal 500a just generates edited content as a duplicate of the original content. Then, the name deciding unit 550 changes the content name of the original content into the content name of the edited content (that is, a copy of the original content), and uses block names of original blocks as block names of edited blocks without changing them.

The display interface unit 580a is connected to the display device 710a (see FIG. 16) and transmits video data and audio data of a video/audio stream to the display device 710a. The display interface unit 580a includes, for example, a High-Definition Multimedia Interface (HDMI) interface.

The scheduled recording information storage unit 590a obtains information (hereinafter, referred to as “original content information”) regarding original content (video/audio program) that is to be broadcast by the original terminal 400a (see FIG. 16) over the CCN network via the communication unit 510, and stores the original content information therein.

The original content information is a data set including the content name of the original content, duration of the real-time stream, the title, the broadcast time period, and text that describes the outline of contents. The original content information is similar to, for example, information described in an electronic program guide (EPG) used in existing television broadcasting.

The scheduled recording information storage unit 590a presents original content information to a user of the editing terminal 500a (hereinafter, simply referred to as a “user”) via the display interface unit 580a, for example. The scheduled recording information storage unit 590a accepts an operation for selecting original content to be recorded from the user. Then, the scheduled recording information storage unit 590a sets the content name of the selected original content as a content name of content to be obtained. Also, the scheduled recording information storage unit 590a sets the recording start time and the recording end time from the broadcast time period of the selected original content.

Then, when the set recording start time comes, the scheduled recording information storage unit 590a instructs the original content obtaining unit 520 to start obtaining the original content. Also, when the set recording end time comes, the scheduled recording information storage unit 590a instructs the original content obtaining unit 520 to end obtaining the original content.

Note that while obtaining original content (while the video/audio program is progressing), each unit of the editing terminal 500a may appropriately display the original content and generate edited content (that is, duplicate the original content).

Also, the scheduled recording information storage unit 590a may instruct the publishing unit 570 to publish the edited content while the original content is being obtained or at a certain timing after obtaining of the original content has been completed.

Desirably, every time the publishing unit 570 publishes index information of edited content, the publishing unit 570 transmits information regarding the content use right of the corresponding original content to the filter management server 730a in association with the index information.

The information regarding the content use right includes, for example, identification information of a user and identification information (for example, content name) of the edited content. The identification information of a user is, for example, a social security number assigned to the user in the United State or a credit card number owned by the user.

The mobile terminal 720a illustrated in FIG. 16 includes, for example, a recorded block data obtaining unit (not illustrated) and a content obtaining/display unit (not illustrated).

The recorded block data obtaining unit accepts a user operation or the like, transmits an interest packet specifying a content name of edited content over the CCN network, and obtains edited blocks of the edited content. A procedure of obtaining edited blocks is similar to the procedure of obtaining original blocks described in the second embodiment.

Note that the recorded block data obtaining unit stores identification information of a user. Before obtaining the edited content, the recorded block data obtaining unit requests the filter management server 730a (see FIG. 16) to insert the above-described filter at the transfer terminals 200a that are directly or indirectly connected to the mobile terminal 720a. This request includes transmission of the information regarding the content use right (identification information of the user and identification information of the edited content).

Thereafter, the recorded block data obtaining unit transmits such information over the CCN network in association with an interest packet requesting index information of the edited content. For example, the recorded block data obtaining unit writes encrypted identification information of the user in a header portion of the interest packet.

The content obtaining/display unit rearranges obtained edited blocks into edited content that is viewable (watchable) by the user, and reproduces the edited content.

In response to the above-described request from the mobile terminal 720a, the filter management server 730a instructs the transfer terminals 200a connected to the mobile terminal 720a to insert a filter that allows an interest packet specifying a specific namespace to pass therethrough. At this time, the filter management server 730a determines whether or not such a request is appropriate. If the request is appropriate, the filter management server 730a inserts the above-described filter. Examples of the case where the request from the mobile terminal 720a is appropriate include the case where the information regarding the content use right received from the mobile terminal 720a matches information regarding the content use right received from the editing terminal 500a.

If the above-described request from the mobile terminal 720a is appropriate, the filter management server 730a adds (inserts) a filter at the transfer terminal 200a. Such a filter is a filter that allows an interest packet specifying the index portion of the recorded content to pass therethrough in the case where association described at the index portion of the edited content is correct. Specifically, the filter management server 730a transmits, for example, the information regarding the content use right (identification information of the user and identification information of the edited content) to the transfer terminal 200a.

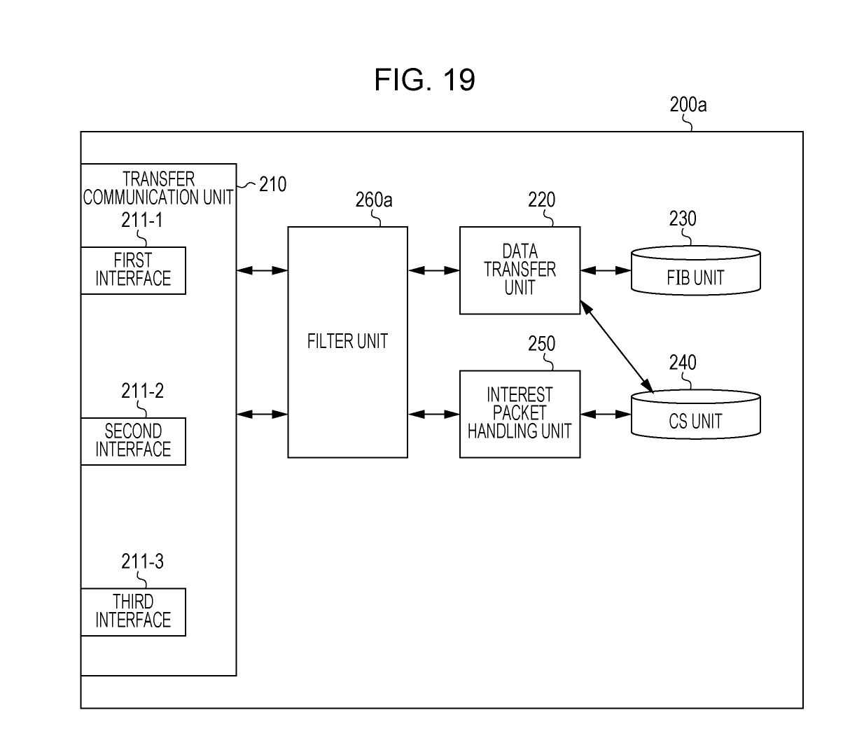

FIG. 19 is a block diagram illustrating an example of a configuration of the transfer terminal 200a, and corresponds to FIG. 6 of the second embodiment. Components similar to those of FIG. 6 are denoted by the same references, and a description thereof is omitted.

Referring to FIG. 19, the transfer terminal 200a includes a filter unit 260a in addition to the configuration illustrated in FIG. 6.

The filter unit 260a is located between the transfer communication unit 210 and the data transfer unit 220 and the interest packet handling unit 250. The filter unit 260a receives the filter inserted by the filter management server 730a, and uses the inserted filter. Specifically, the filter unit 260a receives the information regarding the content use right (identification information of the user and identification information of the edited content) from the filter management server 730a, and implements the filter function on the basis of such information.

Note that in the third embodiment, this filter is a filter that allows only the mobile terminal 720a to obtain video/audio content recorded by the editing terminal 500a as described above. That is, the filter defines, as a condition for an interest packet to be transferred or responded, a correct combination of identification information of edited content requested by the interest packet and identification information of a user attached to the interest packet. An interest packet that meets this condition is a packet transmitted by the user who has the content use right of the edited content.

Note that a third party other than the user possibly transmits an interest packet specifying the content name of the edited content using the identification information of the user in an unauthorized manner. Accordingly, the filter unit 260a desirably uses a transmission source authentication technique, such as ingress filtering, to discriminate and discard such an interest packet transmitted in an unauthorized manner.

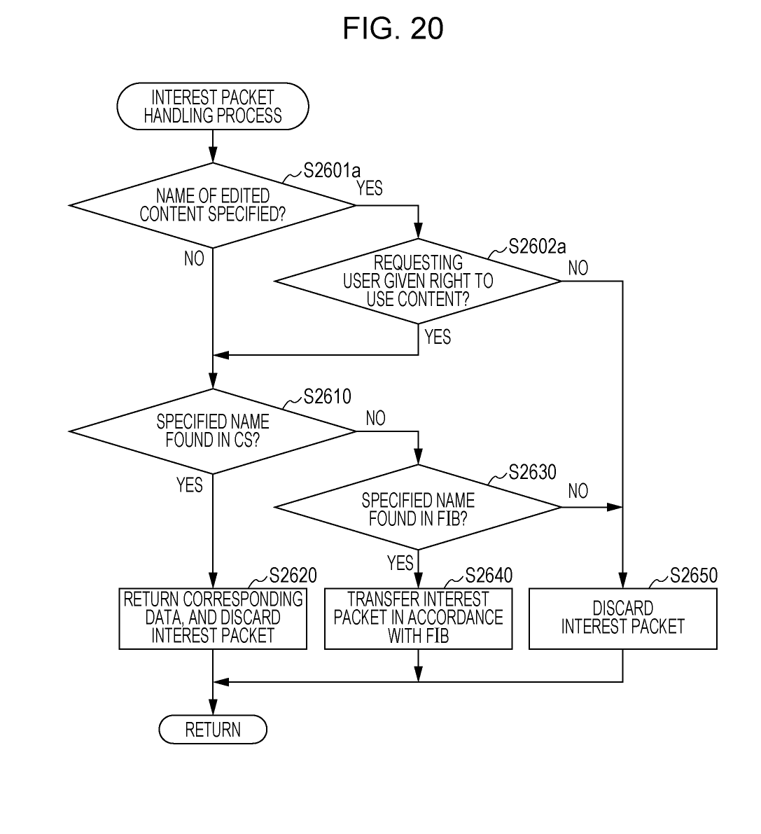

FIG. 20 is a flowchart illustrating an example of the interest packet handling process performed by the transfer terminal 200a, and corresponds to FIG. 14 of the second embodiment. Steps similar to those of FIG. 14 are denoted by the same step numbers, and a description thereof is omitted.

First, in step S2601a, the filter unit 260a determines whether or not a received interest packet specifies a content name of edited content. That is, the filter unit 260a determines whether or not an interest packet requesting index information of edited content has been received.

If the filter unit 260a determines that the received interest packet is not a packet specifying a content name of edited content (S2601a: NO), the filter unit 260a outputs the received interest packet to the interest packet handling unit 250. The process then proceeds to step S2610. Examples of the case where the received interest packet is not a packet specifying a content name of edited content include the case where the received interest packet specifies a block name of an edited block constituting the edited content. If the filter unit 260a determines that the received interest packet is a packet specifying a content name of edited content (S2601a: YES), process proceeds to step S2602a.

In step S2602a, the filter unit 260a determines whether or not a user who is a requester requesting index information of the edited content has the content use right of the edited content. Specifically, the filter unit 260a determines whether or not a combination of identification information of edited content requested by the received interest packet and identification information of the user attached to the received interest packet matches the condition set by the filter.

If the filter unit 260a determines that the user who is a requester requesting index information of the edited content has the content use right of the edited content (S2602a: YES), the process proceeds to step S2610. If the filter unit 260a determines that the user who is a requester requesting index information of the edited content does not have the content use right of the edited content (S2602a: NO), the process proceeds to step S2650.

In the case where the process proceeds to step S2601, the interest packet handling unit 250 performs the interest packet handling process described in the second embodiment via the filter unit 260a. In the case where the process proceeds to step S2650, the interest packet handling unit 250 discards the received interest packet. Note that this discarding of the interest packet may be performed by the filter unit 260a.

As described above, the transfer terminal 200a performs filtering based on the content use right for an interest packet requesting index information, and does not perform such filtering for an interest packet requesting an edited block.

As described above, the editing terminal 500a decides upon, for an edited block (including a block that is the same as the corresponding segment block), a uniquely determined block name in accordance with contents of the block. Further, such a block name is a name that is predictable only by a terminal (user) having obtained the block.

Accordingly, it is difficult to obtain the edited block unless the user has already obtained the original content, the edited content, or the index information. With this configuration, the communications system 100a can limit obtainer(s) of edited content by just performing filtering for an interest packet requesting index information using a simple configuration and process.

Also, as described above, the editing terminal 500a generates a segment block from which an edited block is derived, such that the segment block has the same contents as the corresponding original block. Then, the editing terminal 500a decides upon, for the edited block (including a block that is the same as the segment block), a uniquely determined block name in accordance with contents of the block by using the same rule as that used for the block name of the original block.

Accordingly, a possibly that blocks having the same contents are included in common in content for which a plurality of users have the content use right increases, and a cache hit rate of such a block improves. In this way, the communications system 100a can improve the frequency at which cached content is utilized and enable efficient distribution of edited content while limiting obtainers of the edited content.

As described above, the communications system 100a according to the third embodiment generates an edited block such that the edited block has the same contents as its original block, and decides upon a uniquely determined block name in accordance with contents of the block by using the same rule as that used for the block name of the original block. Also, the communications system 100a according to the third embodiment performs filtering based on the content use right for only interest packets requesting index information.

With this configuration, the communications system 100a according to the third embodiment can enable utilization of cached original content (and other cached edited content) for distribution of edited content even in the case where obtainers of the edited content are limited.

That is, in the use case where nonlinearly edited results obtained by editing one video content into combinations of various scenes are shared over a network, a cache is expected to be retrieved highly efficiently at the CCN network side in the communications system 100a according to the third embodiment. The same also applies to the use case where one content is duplicated by many recipients for private use. As a result, the communications system 100a according to the third embodiment can save the cache capacity in the router and the network bandwidth, and consequently can construct a highly efficient system.

Note that a method for performing filtering on an interest packet requesting index information and a method for setting the filter are not limited to the above-described example. For example, the original terminal 400a or the editing terminal 500a may set a filter directly at each transfer terminal 200a.

In the embodiments described above, edited content can be treated as original content of other edited content. Even in such a case, the block name of the initial original content can be maintained for the other edited content obtained by editing the edited content.

Also, types of original content and edited content are not limited to the above-described examples. Original content and edited content may be, for example, still image data, three-dimensional space data, or text data.

A communications terminal according to an embodiment of the present disclosure is a communications terminal that forms a content centric network and that includes an original content obtaining unit configured to obtain original content including original blocks having names, a content editing unit configured to generate edited content including edited blocks from the original content, a name deciding unit configured to decide upon a name of the edited content and names of the edited blocks, and a publishing unit configured to publish the edited blocks and index information of the edited content, wherein in a case where an edited block, among the edited blocks, has contents identical to contents of a corresponding one of the original blocks, the name deciding unit decides that the name of the original block is to be the name of the edited block.

The communications terminal may further include an edited content storage unit configured to store the edited blocks and the index information of the edited content, wherein upon receipt of an interest packet specifying the name of the edited content, the publishing unit may return the index information of the edited content, and upon receipt of an interest packet specifying the name of an edited block among the edited blocks, the publishing unit may return the edited block.

In the communications terminal, the original content obtaining unit may transmit an interest packet specifying a name of the original content and obtain index information of the original content, and may transmit an interest packet specifying the name of an original block, among the original blocks, included in the index information of the original content and obtain the original block, and the communications terminal may further include an original content storage unit configured to store the obtained original block.

In the communications terminal, the content editing unit may accept editing to be performed on the original content from a user, and generate the edited content.

In the communications terminal, the original content may include real-time stream data, and the content editing unit may include a block size dividing unit configured to obtain segment blocks which are obtained by dividing the real-time stream data of the original content in a size identical to a size of the original blocks, and a block editing unit configured to generate the edited content on the basis of the edited block having contents identical to contents of the corresponding segment block or the edited block obtained by editing the corresponding segment block.

In the communications terminal, the original blocks may be pieces of data obtained by dividing the real-time stream data of the original content in a certain size along a time axis of the real-time stream data with reference to a certain time along the time axis, the original content obtaining unit may obtain all the original blocks included in the original content, and the block size dividing unit may obtain the segment blocks by dividing the real-time stream data of the original content in the certain size along the time axis with reference to the certain time.

In the communications terminal, the block editing unit may accept editing to be performed on the segment blocks from a user and generate the edited blocks, and may accept a decision regarding arrangement of the edited blocks from the user and generate the edited content.

In the communications terminal, in the case where an edited block, among the edited blocks, has contents different from contents of a corresponding one of the original blocks, the name deciding unit may decide that a hash value obtained by applying a certain hash function to the edited block is to be the name of the edited block.

A transfer terminal according to an embodiment of the present disclosure is a transfer terminal that forms a content centric network including the communications terminal, and that includes a data transfer unit configured to transfer an interest packet and data specified by the interest packet between a transmission source of the interest packet and a partner that stores the data; a data cache unit configured to store a duplicate of the data when the data is transferred by the data transfer unit; an interest packet handling unit configured to return, upon receipt of an interest packet specifying the name of the edited content after the index information of the edited content has been stored in the data cache unit, the index information of the edited content, and configured to return, upon receipt of an interest packet specifying the name of an edited block among the edited blocks after the edited block has been stored in the data cache unit, the edited block; and a filter unit configured to impose a limitation such that the interest packet specifying the name of the edited content is transferred by the data transfer unit and the index information of the edited content is returned in response to the interest packet by the interest packet handling unit in a case where a user at the transmission source of the interest packet has a right to obtain the edited content.

A content publication method according to an embodiment of the present disclosure is a content publication method, over a content centric network, including obtaining original content including original blocks having names; generating edited content including edited blocks from the original content; deciding upon a name of the edited content and names of the edited blocks; and publishing the edited blocks and index information of the edited content, wherein in the step of deciding upon names of the edited blocks, in a case where an edited block, among the edited blocks, has contents identical to contents of a corresponding one of the original blocks, the name of the original block is decided to be the name of the edited block.

The embodiments of the present disclosure are made use of as a communications terminal and a content publication method that enable utilization of cached original content for distribution of edited content.

What is claimed is:

1. A communications terminal that forms a content centric network, comprising a first processor, said first processor is operable to:
obtain original content including original blocks having names;
generate edited content including edited blocks from the original content;
decide upon a name of the edited content and names of the edited blocks; and
publish the edited blocks and index information of the edited content, wherein
in a case where an edited block, among the edited blocks, has contents identical to contents of a corresponding one of the original blocks, said first processor is operable to decide that the name of the original block is to be the name of the edited block.

2. The communications terminal according to claim 1, further comprising a first storage device, said first processor is operable to:
store the edited blocks and the index information of the edited content in said first storage device, wherein
upon receipt of an interest packet specifying the name of the edited content, said first processor is operable to return the index information of the edited content, and
upon receipt of an interest packet specifying the name of an edited block among the edited blocks, said first processor is operable to return the edited block.

3. The communications terminal according to claim 1, wherein
said first processor is operable to transmit an interest packet specifying a name of the original content and obtain index information of the original content, and transmit an interest packet specifying the name of an original block, among the original blocks, included in the index information of the original content and obtain the original block, and
the communications terminal further comprises a first storage device, said first processor is operable to:
store the obtained original block in said first storage device.

4. The communications terminal according to claim 3, wherein said first processor is operable to accept editing to be performed on the original content from a user, and generate the edited content.

5. The communications terminal according to claim 4, wherein
the original content includes real-time stream data, and
said first processor is operable to
obtain segment blocks which are obtained by dividing the real-time stream data of the original content in a size identical to a size of the original blocks, and
generate the edited content on the basis of the edited block having contents identical to contents of the corresponding segment block or the edited block obtained by editing the corresponding segment block.

6. The communications terminal according to claim 5, wherein
the original blocks are pieces of data obtained by dividing the real-time stream data of the original content in a certain size along a time axis of the real-time stream data with reference to a certain time along the time axis,
said first processor is operable to obtain all the original blocks included in the original content, and
obtain the segment blocks by dividing the real-time stream data of the original content in the certain size along the time axis with reference to the certain time.

7. The communications terminal according to claim 5, wherein said first processor is operable to accept editing to be performed on the segment blocks from a user and generate the edited blocks, and accept a decision regarding arrangement of the edited blocks from the user and generates the edited content.

8. The communications terminal according to claim 7, wherein in a case where an edited block, among the edited blocks, has contents different from contents of a corresponding one of the original blocks, said first processor is operable to decide that a hash value obtained by applying a certain hash function to the edited block is to be the name of the edited block.

9. A transfer terminal that forms a content centric network including the communications terminal according to claim 8, comprising a second processor and a second storage device, said second processor is operable to:
transfer an interest packet and data specified by the interest packet between a transmission source of the interest packet and a partner that stores the data;
store a duplicate of the data in said second storage device when the data is transferred;
return, upon receipt of an interest packet specifying the name of the edited content after the index information of the edited content has been stored in said second storage device, the index information of the edited content, and return, upon receipt of an interest packet specifying the name of an edited block among the edited blocks after the edited block has been stored in said second storage device, the edited block; and
impose a limitation such that the interest packet specifying the name of the edited content is to be transferred and the index information of the edited content is to be returned in response to the interest packet in a case where a user at the transmission source of the interest packet has a right to obtain the edited content.

10. A content publication method over a content centric network by using a processor, comprising:
obtaining original content including original blocks having names;
generating edited content including edited blocks from the original content;
deciding upon a name of the edited content and names of the edited blocks; and
publishing the edited blocks and index information of the edited content, wherein
in the step of deciding upon names of the edited blocks, in a case where an edited block, among the edited blocks, has contents identical to contents of a corresponding one of the original blocks, the name of the original block is decided to be the name of the edited block.
